(19) United States
(12) Patent Application Publication
(10) Pub. No.: US 2019/0335374 A1
(43) Pub. Date: Oct. 31, 2019

(54) TERMINAL DEVICE, BASE STATION DEVICE, WIRELESS COMMUNICATION SYSTEM, WIRELESS COMMUNICATION METHOD AND PROGRAM

(71) Applicant: SHARP KABUSHIKI KAISHA, Sakai City (JP)

(72) Inventors: SHUICHI TAKEHANA, Sakai City (JP); SHIGETO SUZUKI, Sakai City (JP); KENNICHI IIJIMA, Sakai City (JP); MAKOTO YAMAMOTO, Sakai City (JP)

(21) Appl. No.: 16/385,772

(22) Filed: Apr. 16, 2019

(30) Foreign Application Priority Data
Apr. 26, 2018 (JP) 2018-085783

(51) Int. Cl. H04W 36/30; H04W 24/08; H04W 36/00

(52) U.S. Cl. CPC H04W 36/30; H04W 36/0085; H04W 24/08

(57) ABSTRACT

A terminal device includes: a communication unit; and a control unit. The control unit transmits a measurement result relating to a radio wave environment and connection switching means information indicating which of two or more means of connection switching to another base station device is used to a first base station device through the communication unit, receives instruction information corresponding to the transmitted connection switching means information from the first base station device through the communication unit, and performs connection with a second base station device based on the instruction information.

### BACKGROUND OF THE INVENTION

### Field of the Invention

The present invention relates to a terminal device, a base station device, a wireless communication system, a wireless communication method, and a program.

### Description of Related Art

In the 3rd Generation Partnership Project (3GPP) RAN2, conditional handover (CHO) has been examined (see, for example, Non-Patent Document 1). In CHO, a movement source base station device is notified of measurement results of a plurality of base station devices or cells serving as candidates for handover from a connected terminal device. The movement source base station device selects one or a plurality of candidate base station devices or candidate cells serving as handover destinations based on the measurement results. The movement source base station device transmits a handover command to the selected one or plurality of candidate base station devices or candidate cells. In a case where the handover command is received, the candidate base station device secures radio resources allocated to a terminal device after handover.

### Patent Document

[Non-Patent Document 1] “Analysis on conditional handover,” Huawei, 3GPP TSG-RAN WG2 #97 bis R2-1703384, Mar. 24, 2017

### SUMMARY OF THE INVENTION

However, for example, in a case where a plurality of terminal devices perform CHO simultaneously, the candidate base station device needs to secure radio resources with respect to each of a plurality of terminal devices regardless of whether serving as a handover destination in reality. For this reason, in a technique disclosed in Non-Patent Document 1, useless occupation of radio resources occurs, which leads to concern regarding deficiency in radio resources. As seen from the above, there is a problem in that it may not be possible to effectively utilize radio resources.

The present invention was contrived in view of the above points, and an object thereof is to provide a terminal device, a base station device, a wireless communication system, a wireless communication method and a program which make it possible to effectively utilize radio resources.

(1) The present invention is made to solve the above-described problem. One aspect of the present invention is a wireless communication system including: a terminal device; a first base station device; and a second base station device, wherein the terminal device includes a terminal device communication unit and a terminal device control unit, the terminal device control unit transmits a measurement result relating to a radio wave environment and connection switching means information indicating which of two or more means of connection switching to another base station device is used to the first base station device through the terminal device communication unit, receives instruction information corresponding to the transmitted connection switching means information from the first base station device through the terminal device communication unit, and performs connection with the second base station device based on the instruction information, the first base station device includes a first base station device control unit and a first base station device communication unit, and the first base station device control unit receives the measurement result and the connection switching means information from the terminal device through the first base station device communication unit, and transmits instruction information corresponding to the received connection switching means information to the terminal device through the first base station device communication unit.

(2) In addition, the present invention is made to solve the above-described problem. One aspect of the present invention is a terminal device including: a communication unit; and a control unit, wherein the control unit transmits a measurement result relating to a radio wave environment and connection switching means information indicating which of two or more means of connection switching to another base station device is used to a first base station device through the communication unit, receives instruction information corresponding to the transmitted connection switching means information from the first base station device through the communication unit, and performs connection with a second base station device based on the instruction information.

(3) In addition, in one aspect of the present invention, the connection switching means information may include first information indicating whether a host device performs handover.

(4) In addition, in one aspect of the present invention, the first information may include information indicating a use state of the terminal device.

(5) In addition, in one aspect of the present invention, the instruction information may include reconnection instruction information.

(6) In addition, in one aspect of the present invention, the control unit may start a timer in a case where the measurement result is transmitted through the communication unit, and may cut off connection with the first base station device in a case where the timer expires.

(7) In addition, the present invention is made to solve the above-described problem. One aspect of the present invention is a base station device including: a control unit; and a communication unit, wherein the control unit receives a measurement result relating to a radio wave environment and connection switching means information indicating which of two or more means of connection switching to another base station device is used from a terminal device through the communication unit, and transmits instruction information corresponding to the received connection switching means information to the terminal device through the communication unit.

(8) In addition, the present invention is made to solve the above-described problem. One aspect of the present invention is a wireless communication method including causing a computer of a terminal device to: transmit a measurement result relating to a radio wave environment and connection switching means information indicating which of two or more means of connection switching to another base station device is used to the first base station device; receive instruction information corresponding to the transmitted connection switching means information from the first base station device; and perform connection with a second base station device based on the instruction information.

(9) In addition, the present invention is made to solve the above-described problem. One aspect of the present invention is a wireless communication method including causing a computer of a first base station device to: receive a measurement result relating to a radio wave environment and connection switching means information indicating which of two or more means of connection switching to another base station device is used from a terminal device; and transmit instruction information corresponding to the received connection switching means information to the terminal device.

(10) In addition, the present invention is made to solve the above-described problem. One aspect of the present invention is a non-transitory computer readable recording medium storing a program for causing a computer of a terminal device to execute: transmitting a measurement result relating to a radio wave environment and connection switching means information indicating which of two or more means of connection switching to another base station device is used to a first base station device; receiving instruction information corresponding to the transmitted connection switching means information from the first base station device; and performing connection with a second base station device based on the instruction information.

(11) In addition, the present invention is made to solve the above-described problem. One aspect of the present invention is a non-transitory computer readable recording medium storing a program for causing a computer of a first base station device to execute: receiving a measurement result relating to a radio wave environment and connection switching means information indicating which of two or more means of connection switching to another base station device is used from a terminal device; and transmitting instruction information corresponding to the received connection switching means information to the terminal device.

According to the present invention, it is possible to effectively utilize radio resources.

### BRIEF DESCRIPTION OF THE DRAWINGS

FIG. 1 is a schematic diagram illustrating an example of a system configuration of a wireless communication system according to a first embodiment of the present invention.

FIG. 2 is a schematic block diagram illustrating an example of a functional configuration of a terminal device according to the first embodiment of the present invention.

FIG. 3 is a schematic block diagram illustrating an example of a hardware configuration of the terminal device according to the first embodiment of the present invention.

FIG. 4 is a schematic block diagram illustrating an example of a functional configuration of a movement source base station device according to the first embodiment of the present invention.

FIG. 5 is a schematic block diagram illustrating an example of a functional configuration of a movement destination base station device according to the first embodiment of the present invention.

FIG. 6 is a schematic block diagram illustrating an example of a hardware configuration of a base station device according to the first embodiment of the present invention.

FIG. 7 is a flow chart illustrating an example of a first-type handover process in the movement source base station device according to the first embodiment of the present invention.

FIG. 8 is a sequence diagram illustrating an example of the first-type handover process according to the first embodiment of the present invention.

FIG. 9 is a schematic block diagram illustrating an example of a functional configuration of a movement source base station device according to a second embodiment of the present invention.

FIG. 10 is a schematic block diagram illustrating an example of a functional configuration of a movement destination base station device according to the second embodiment of the present invention.

FIG. 11 is a flow chart illustrating an example of a handover process of the movement source base station device according to the second embodiment of the present invention.

FIG. 12 is a sequence diagram illustrating an example of a second-type handover process according to the second embodiment of the present invention.

FIG. 13 is a schematic block diagram illustrating an example of a functional configuration of a terminal device according to a third embodiment of the present invention.

FIG. 14 is a schematic block diagram illustrating an example of a functional configuration of a movement source base station device according to a third embodiment of the present invention.

FIG. 15 is a flow chart illustrating an example of a handover process of the movement source base station device according to the third embodiment of the present invention.

FIG. 16 is a sequence diagram illustrating an example of a second-type handover process according to the modification example of the present invention.

FIG. 17 is a sequence diagram illustrating an example of a reconnection process according to the modification example of the present invention.

FIG. 18 is a sequence diagram illustrating another example of the reconnection process according to the modification example of the present invention.

FIG. 19 is a table indicating an example of a handover type determination table according to the modification example of the present invention.

### DETAILED DESCRIPTION OF THE INVENTION

(First Embodiment)

Hereinafter, a first embodiment of the present invention will be described with reference to the accompanying drawings.

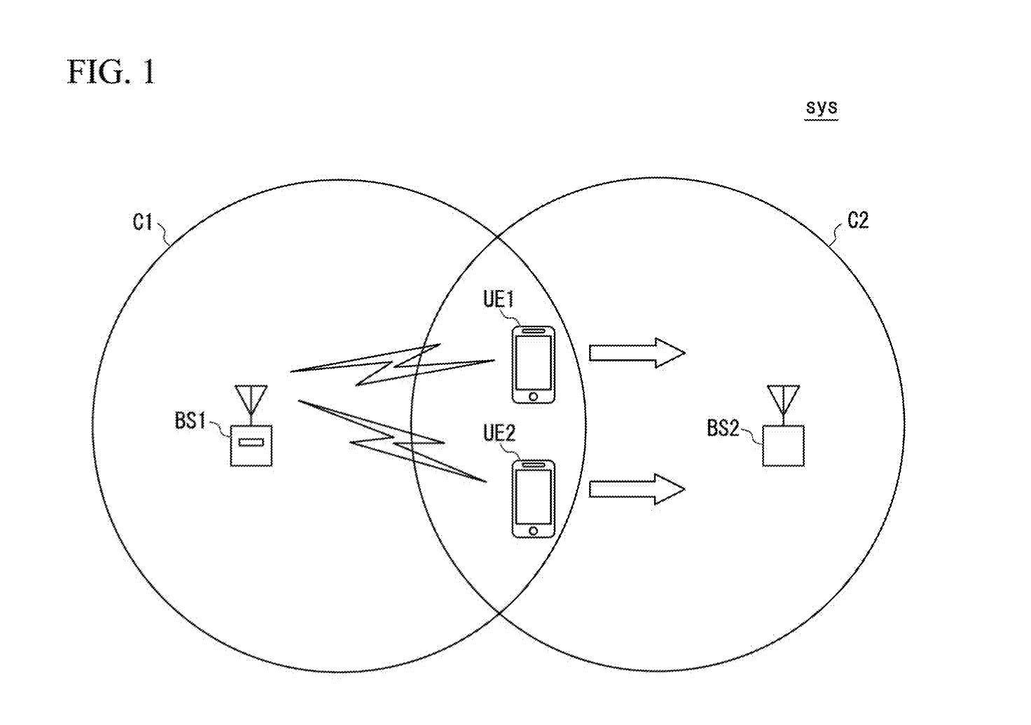

FIG. 1 is a schematic diagram illustrating an example of a system configuration of a wireless communication system according to the first embodiment of the present invention.

A wireless communication system sys is configured to include one or a plurality of base station devices and one or a plurality of terminal devices. For example, the wireless communication system sys is configured to include a movement source base station device BS1, a candidate base station device BS2, a terminal device UE1, and a terminal device UE2. The movement source base station device BS1 forms a cell C1, and communicates with terminal devices belonging to the cell C1. The candidate base station device BS2 forms a cell C2, and communicates with terminal devices belonging to the cell C2. The movement source base station device BS1 and the candidate base station device BS2 communicate with each other in a wired or wireless manner.

The movement source base station device BS1 and the candidate base station device BS2 may communicate with a core network, an MME (both not shown), and the like.

The movement source base station device BS1 communicates with the terminal device UE1 and the terminal device UE2.

For example, in a case where either or both of the terminal device UE1 and the terminal device UE2 are present in the vicinity of the cell edge of the cell C1, the communication quality between the movement source base station device BS1 and the terminal device UE1 or the communication quality between the movement source base station device BS1 and the terminal device UE2 becomes lower than in a case where the terminal device(s) is (are) not in the vicinity of the cell edge. In this case, the movement source base station device BS1 instructs the terminal device UE1 and the terminal device UE2 to perform measurement (Measurement Control) of the communication quality, and causes the terminal device UE1 and the terminal device UE2 to transmit the measurement of the communication quality and a report (Measurement Report) of the measured communication quality. The movement source base station device BS1 starts a handover process for causing, for example, the candidate base station device BS2 to perform handover based on the report of the communication quality received from the terminal device UE1 or the terminal device UE2. In this handover process, it is assumed that the movement source base station device BS1 determines the candidate base station device BS2 to be a movement destination base station device. The movement source base station device BS1 establishes communication between the candidate base station device BS2 and the terminal device UE1 by communicating various messages or the like with the candidate base station device BS2 determined to be a movement destination base station device and the terminal device UE1. In a case where the communication between the candidate base station device BS2 and the terminal device UE1 is established, the communication between the movement source base station device BS1 and the terminal device UE1 is cut off.

In the present embodiment, a description will be given of a first-type handover process in a case where, when the movement source base station device BS1 and the terminal device UE1 communicate with each other in this manner, first-type handover to the candidate base station device BS2 is performed, and the communication between the candidate base station device BS2 and the terminal device UE1 is established. Here, the first-type handover is handover which is not conditional handover (CHO). The first-type handover is, for example, a legacy handover, legacy-based handover, or the like.

First, a functional configuration of the terminal device UE1 will be described.

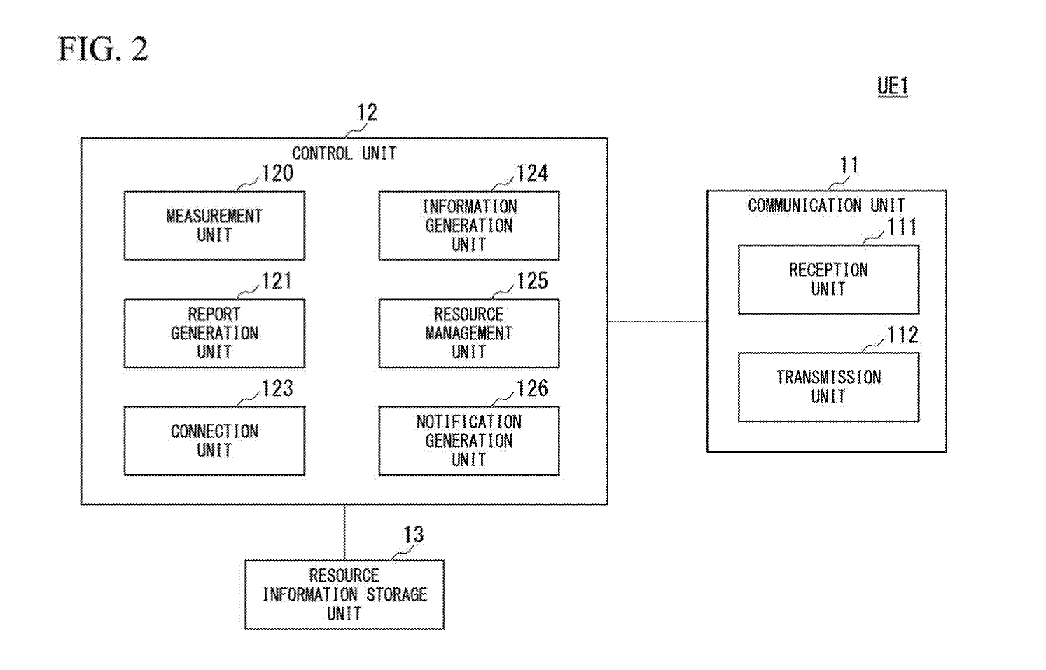

FIG. 2 is a schematic block diagram illustrating an example of a functional configuration of the terminal device UE1 according to the first embodiment of the present invention.

The terminal device UE1 is configured to include a communication unit 11, a control unit 12, and a resource information storage unit 13. The communication unit 11 is configured to include a reception unit 111 and a transmission unit 112.

The control unit 12 is configured to include a measurement unit 120, a report generation unit 121, a connection unit 123, an information generation unit 124, a resource management unit 125, and a notification generation unit 126.

Here, in the following description, in a case where base station devices are not required to be particularly distinguished from each other, these base station devices are simply referred to as the base station device BS.

The communication unit 11 communicates with base station devices such as the movement source base station device BS1 and the movement destination base station device BS2 (also referred to as a candidate base station device) using, for example, the fifth generation mobile communication system (5G). The reception unit 111 receives various types of data or control information from the base station device BS, and outputs the received data or information to the control unit 12. The transmission unit 112 transmits various types of data or control information input from the control unit 12 to the base station device BS.

Meanwhile, the communication unit 11 may perform various types of communication processing such as encoding/decoding, modulation/demodulation, or up-conversion/down-conversion with respect to various types of data or control information transmitted and received to and from the base station device BS.

The control unit 12 controls various functions of the terminal device UE1. The specific details are as follows.

In a case where Measurement Control for indicating an instruction for the measurement of communication quality is received from the movement source base station device BS1 through the reception unit 111 during communication with the terminal device UE1 and the movement source base station device BS1, the measurement unit 120 measures a radio wave environment between the base station device BS of a peripheral cell and the terminal device. The measurement of the radio wave environment is, for example, measurement of a quality value indicating a reception quality such as the received power, block error rate, frame error rate, or throughput of a received signal from the base station device BS of a peripheral cell, or the like. The measurement unit 120 outputs a measurement result to the report generation unit 121.

In a case where the measurement result is input from the measurement unit 120, the report generation unit 121 generates Measurement Report by associating identification information for identifying the base station device BS of a peripheral cell with the communication quality of the base station device BS. Measurement Report includes information of a terminal device relating to handover indicating a desired handover (for example, first-type handover (HO)) (for example, information (such as a flag) indicating whether the first-type handover is executed). The information of a terminal device relating to handover is also referred to as first information. The first information is also referred to as connection switching information relating to connection switching to another base station device or connection switching means information to another base station device. The report generation unit 121 transmits the generated Measurement Report to the movement source base station device BS1 through the transmission unit 112.

In a case where a first-type handover instruction (instruction information, an HO instruction) indicating an instruction for the first-type handover from the movement source base station device BS1 to another base station device BS (for example, the movement destination base station device BS2) is received from the base station device BS1 through the reception unit 111, the connection unit 123 is connected to the movement destination base station device BS2, and starts a synchronization process with the movement destination base station device BS2. The connection unit 123 outputs a signal indicating that the synchronization process has started to the information generation unit 124.

In a case where the signal indicating that the synchronization process has started is input from the connection unit 123, the information generation unit 124 generates synchronization information, and transmits the generated information to the base station device BS2. The synchronization information is various types of information for synchronizing with the base station device BS2, and is, for example, information indicating the status of transmission and reception of various types of data.

In a case where resource allocation information is received from the movement destination base station device BS2 through the reception unit 111, the resource management unit 125 stores the resource allocation information in the resource information storage unit 13. The resource management unit 125 sets resources for communication with the base station device BS2 in the terminal device UE1 based on the received resource allocation information. The resource management unit 125 outputs a signal indicating that the setting of the resources is completed to the notification generation unit 126.

In a case where the signal indicating that the setting of the resources is completed is input from the resource management unit 125, the notification generation unit 126 generates a first-type handover completion notification (HO completion notification) indicating that the first-type handover process is completed. The notification generation unit 126 transmits the generated first-type handover completion notification to the movement destination base station device BS2 through the transmission unit 112.

The resource information storage unit 13 stores resource information for each communicating base station device BS.

The resource information includes an uplink resource and a downlink resource.

Next, a hardware configuration of the terminal device UE1 will be described.

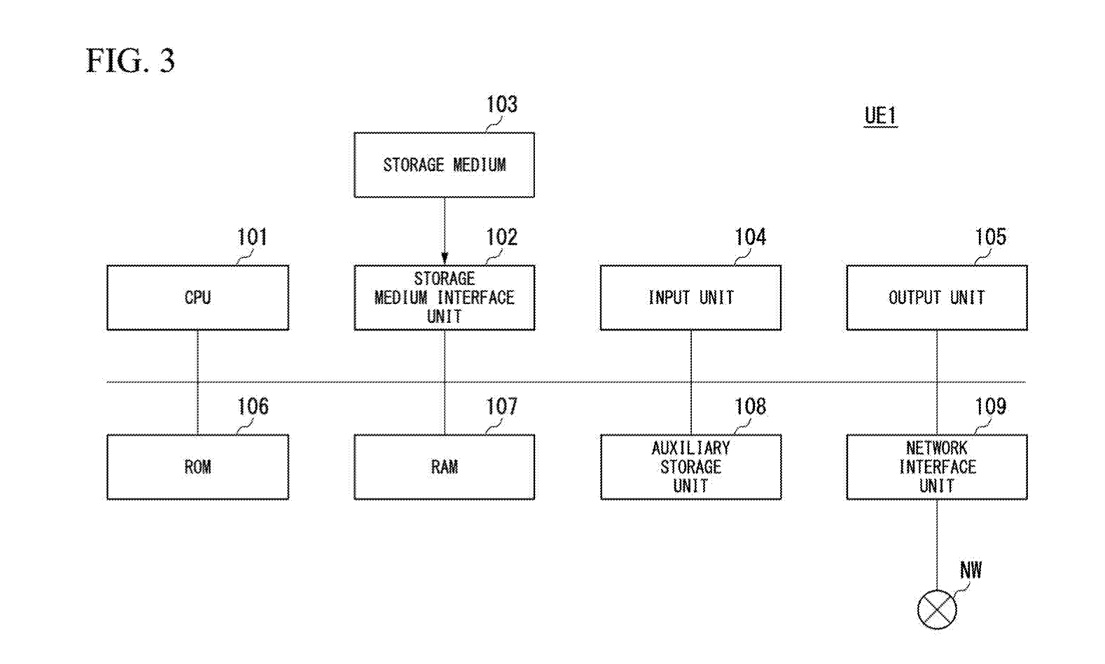

FIG. 3 is a schematic block diagram illustrating an example of a hardware configuration of the terminal device UE1 according to the first embodiment of the present invention.

The terminal device UE1 includes a CPU 101, a storage medium interface unit 102, a storage medium 103, an input unit 104, an output unit 105, a read only memory (ROM) 106, a random access memory (RAM) 107, an auxiliary storage unit 108, and a network interface unit 109. The CPU 101, the storage medium interface unit 102, the input unit 104, the output unit 105, the ROM 106, the RAM 107, the auxiliary storage unit 108, and the network interface unit 109 are connected to each other through a bus.

Meanwhile, the CPU 101 as used herein indicates a processor in general, and includes not only a device called a so-called CPU in a narrow sense, but also, for example, a GPU, a DSP or the like. In addition, the CPU 101 as used herein may be realized by combining a plurality of processors of the same or different kind without being limited to being realized by one processor.

The CPU 101 controls the terminal device UE1 by reading out and executing programs which are stored by the auxiliary storage unit 108, the ROM 106 and the RAM 107, reading out various types of data which are stored by the auxiliary storage unit 108, the ROM 106 and the RAM 107, and writing various types of data in the auxiliary storage unit 108 and the RAM 107. In addition, the CPU 101 reads out various types of data which are stored by the storage medium 103 through the storage medium interface unit 102, and writes various types of data in the storage medium 103. The storage medium 103 is a portable storage medium such as a magnetooptic disc, a flexible disk, or a flash memory, and stores various types of data.

The storage medium interface unit 102 is an interface that performs reading and writing of the storage medium 103.

The input unit 104 is an input device such as a mouse, a keyboard, a touch panel, a sound volume adjustment button, a power button, a setting button, or an infrared reception unit.

The output unit 105 is an output device such as a display unit or a speaker.

The ROM 106 and the RAM 107 store programs or various types of data for bringing each functional unit of the terminal device UE1 into operation.

The auxiliary storage unit 108 is a hard disk drive, a flash memory or the like, and stores programs or various types of data for bringing each functional unit of the terminal device UE1 into operation.

The network interface unit 109 has a communication interface, and is connected to a network NW through wireless communication such as, for example, 5G.

For example, the communication unit 11 in the functional configuration of the terminal device UE1 in FIG. 2 corresponds to the network interface unit 109 in the hardware configuration shown in FIG. 3. In addition, for example, the control unit 12 in the functional configuration of the terminal device UE1 in FIG. 2 corresponds to the CPU 101 in the hardware configuration shown in FIG. 3. In addition, for example, the resource information storage unit 13 in the functional configuration of the terminal device UE1 in FIG. 2 corresponds to the ROM 106, the RAM 107 or the auxiliary storage unit 108 in the hardware configuration shown in FIG. 3, or any combination thereof.

Next, the functional configuration of the movement source base station device BS1 will be described.

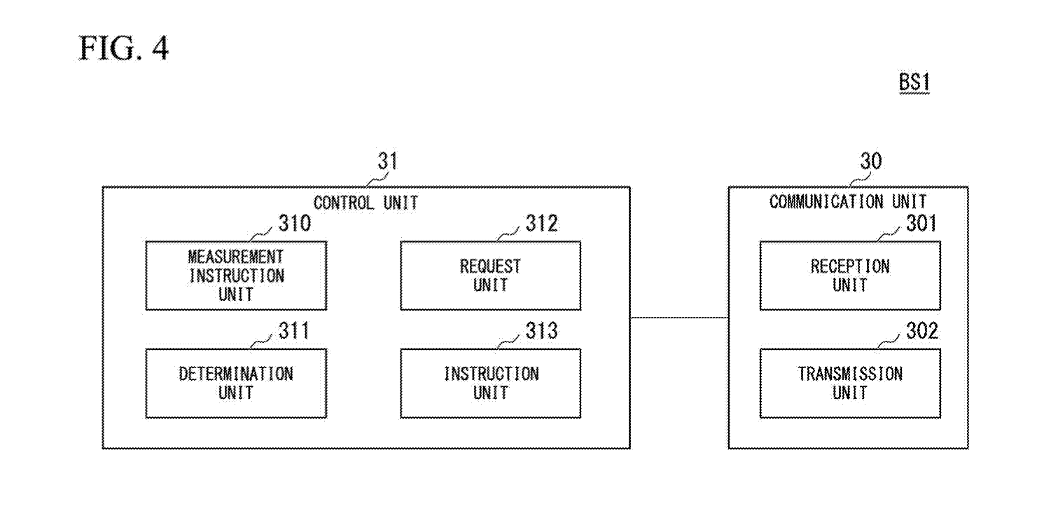

FIG. 4 is a schematic block diagram illustrating an example of a functional configuration of the movement source base station device BS1 according to the first embodiment of the present invention.

Here, in order to distinguish between a base station device which is a movement source and a base station device which is a movement destination in the first-type handover, in the following description, the base station device BS1 is defined as a movement source base station device, and the base station device BS2 is defined as a candidate base station device serving as a candidate for a movement destination. The number of candidate base station devices may be plural rather than one. In a case where the number of candidate base station devices is one, the one candidate base station device serves as a movement destination base station device. In a case where the number of candidate base station devices is plural, any of the plurality of candidate base station devices serves as a movement destination base station device.

The movement source base station device BS1 is configured to include a communication unit 30 and a control unit 31. The communication unit 30 is configured to include a reception unit 301 and a transmission unit 302. The control unit 31 is configured to include a measurement instruction unit 310, a determination unit 311, a request unit 312, and an instruction unit 313.

The communication unit 30 communicates with another base station device BS (for example, the base station device BS2) or the terminal device UE such as the terminal device UE1 using, for example, the fifth generation mobile communication system (5G).

The reception unit 301 receives various types of data or control information from the base station device BS2, and outputs the received data or information to the control unit 31. In addition, the reception unit 301 receives various types of data or control information from the terminal device UE1, and outputs the received data or information to the control unit 31. The transmission unit 302 transmits various types of data or control information input from the control unit 31 to the base station device BS2. In addition, the transmission unit 302 transmits various types of data or control information input from the control unit 31 to the terminal device UE1.

Meanwhile, the communication unit 30 may perform various types of communication processing such as encoding/decoding, modulation/demodulation, or up-conversion/down-conversion with respect to various types of data or control information transmitted and received to and from the base station device BS or the terminal device UE.

The control unit 31 controls the movement source base station device BS1. The specific details are as follows.

The measurement instruction unit 310 generates Measurement Control indicating an instruction for the measurement of the communication quality of a base station device of a peripheral cell with respect to the terminal device UE1. The measurement instruction unit 310 transmits the generated Measurement Control to the terminal device UE1 through the transmission unit 302. The generation (transmission) of Measurement Control may be performed in a predetermined period, and may satisfy predetermined conditions, or may not satisfy predetermined conditions.

In a case where Measurement Report indicating the measurement result of the communication quality is received from the terminal device UE1 through the reception unit 301, the determination unit 311 determines whether the first-type handover is to be performed by the terminal device UE1 based on information of a terminal device relating to handover included in Measurement Report, a communication quality for each base station device BS (candidate base station device BS) of a peripheral cell, and a communication quality between a host device and the terminal device UE1. The determination unit 311 determines that, for example, a desired handover indicated by the information of a terminal device relating to handover is the first-type handover, and determines the base station device BS2 to be a movement destination base station device from among the candidate base station devices BS based on the communication quality. In a case where the first-type handover of the terminal device UE1 is determined, the determination unit 311 outputs a signal indicating the determination to the request unit 312.

In a case where the signal indicating the determination is input from the determination unit 311, the request unit 312 generates a first-type handover request indicating a request for the first-type handover to the movement destination base station device BS2. The request unit 312 transmits the generated first-type handover request to the movement destination base station device BS2 through the transmission unit 302.

In a case where a first-type handover response is received, as a response to the first-type handover request transmitted by the request unit 312, from the movement destination base station device BS2 through the reception unit 301, the instruction unit 313 generates a first-type handover instruction (instruction information) indicating an instruction for handover to the movement destination base station device BS2. The instruction unit 313 transmits the generated first-type handover instruction to the terminal device UE1 through the transmission unit 302.

In addition, in a case where the first-type handover instruction is transmitted to the terminal device UE1, the instruction unit 313 transmits SN Status Transfer, as information indicating the status of transmission and reception of data to and from the terminal device UE1, to the movement destination base station device BS2 through the transmission unit 302.

Next, the functional configuration of the movement destination base station device BS2 will be described.

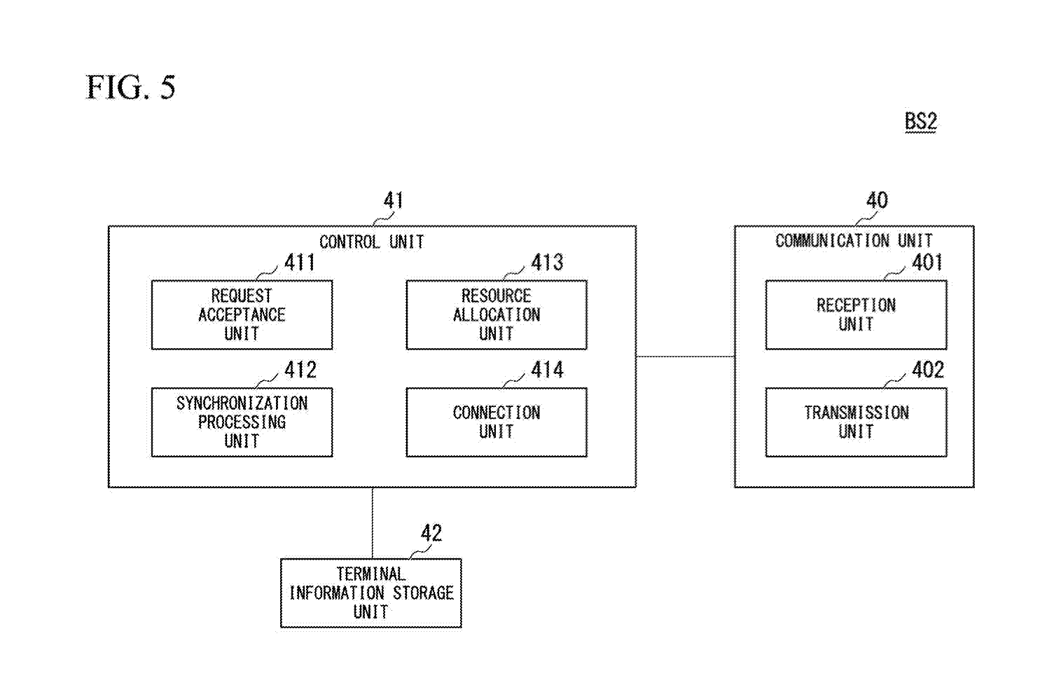

FIG. 5 is a schematic block diagram illustrating an example of a functional configuration of the movement destination base station device BS2 according to the first embodiment of the present invention.

Here, in the present embodiment, a case where the base station device BS2 which is one of the candidate base station devices BS is the movement destination base station device BS2 as described above will be described, but the candidate base station device may have the same configuration as that of the movement destination base station device BS2.

The movement destination base station device BS2 is configured to include a communication unit 40, a control unit 41, and a terminal information storage unit 42. The communication unit 40 is configured to include a reception unit 401 and a transmission unit 402. The control unit 41 is configured to include a request acceptance unit 411, a synchronization processing unit 412, a resource allocation unit 413, and a connection unit 414.

The communication unit 40 communicates with another base station device BS (for example, base station device BS1) or the terminal device UE such as the terminal device UE1 using, for example, the fifth generation mobile communication system (5G).

The reception unit 401 receives various types of data or control information from the base station device BS1, and outputs the received data or information to the control unit 41. In addition, the reception unit 401 receives various types of data or control information from the terminal device UE1, and outputs the received data or information to the control unit 41. The transmission unit 402 transmits various types of data or control information input from the control unit 41 to the base station device BS1. In addition, the transmission unit 402 transmits various types of data or control information input from the control unit 41 to the terminal device UE1.

Meanwhile, the communication unit 40 may perform various types of communication processing such as encoding/decoding, modulation/demodulation, or up-conversion/down-conversion with respect to various types of data or control information transmitted and received to and from the base station device BS or the terminal device UE.

The control unit 41 controls the movement destination base station device BS2. The specific details are as follows.

In a case where the first-type handover request (HO request) is received from the movement source base station device BS1 through the reception unit 401, the request acceptance unit 411 executes a first-type handover acceptance process. The first-type handover acceptance process is various types of process for operation in a movement destination base station device for handover, and is, for example, various types of negotiation between the movement source base station device BS1 and the movement destination base station device BS2, or the like. In a case where the first-type handover acceptance process is completed, the request acceptance unit 411 transmits the first-type handover response (HO response), as a response to the first-type handover request, to the movement source base station device BS1 through the transmission unit 402.

In a case where SN Status Transfer is received from the movement source base station device BS1 through the reception unit 401, the synchronization processing unit 412 performs a synchronization process with the terminal device UE1. In a case where the synchronization process with the terminal device UE1 is completed, the synchronization processing unit 412 outputs a synchronization completion signal to the resource allocation unit 413.

In a case where the synchronization completion signal is input from the synchronization processing unit 412, the resource allocation unit 413 notifies the terminal device UE1 of radio resources allocated to the terminal device UE1 as resource allocation information. In addition, the resource allocation unit 413 stores the resource allocation information of the terminal device UE1 and identification information of the terminal device UE1 in the terminal information storage unit 42 in association with each other.

In a case where the first-type handover completion notification (HO completion notification) is received from the terminal device UE1 through the reception unit 401, the connection unit 414 is connected to the terminal device UE1, and communicates with the terminal device.

The terminal information storage unit 42 stores the identification information of the terminal device and the resource allocation information for each terminal device in association with each other.

Meanwhile, the movement source base station device BS1 and the movement destination base station device BS2 may be base station devices having both functions of the movement source base station device BS1 and the movement destination base station device BS2.

Next, the hardware configurations of the movement source base station device BS1 and the movement destination base station device BS2 will be described.

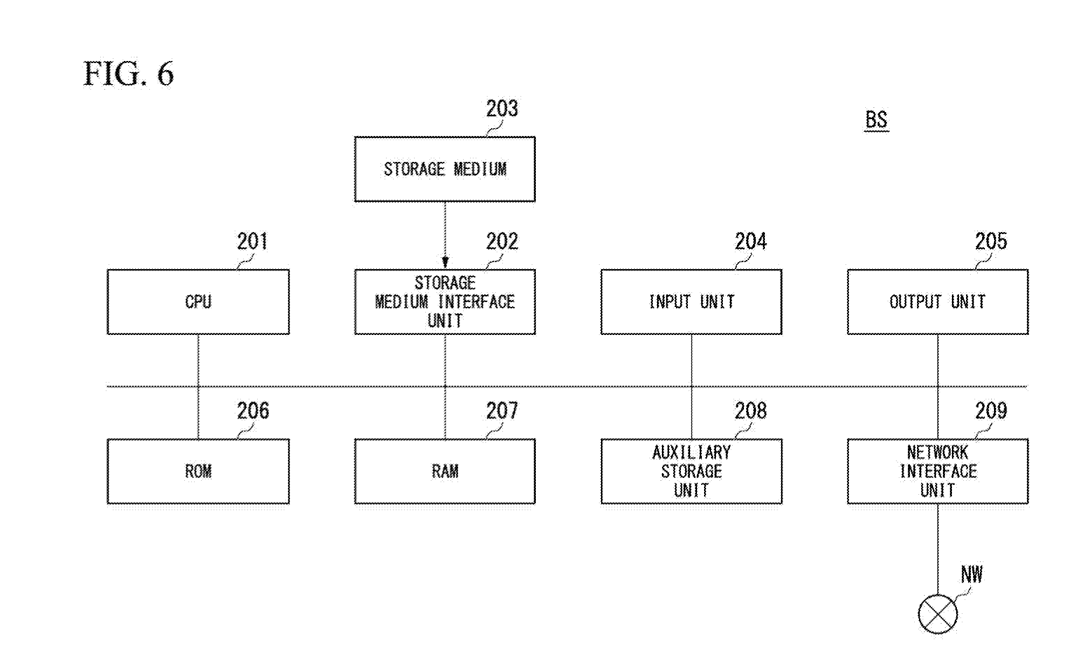

FIG. 6 is a schematic block diagram illustrating an example of a hardware configuration of the base station device according to the first embodiment of the present invention.

Here, in the present embodiment, an example in a case where the functional configuration of the movement source base station device BS1 and the functional configuration of the movement destination base station device BS2 are different from each other will be described, but the movement source base station device BS1 and the movement destination base station device BS2 may be base station devices having both functions of the movement source base station device BS1 and the movement destination base station device BS2. Irrespective of a case where the movement source base station device BS1 and the movement destination base station device BS2 have functional configurations different from each other, or a case where the movement source base station device BS1 and the movement destination base station device BS2 have the same functional configuration as each other, the hardware configurations thereof are the same as each other, and thus these will be described as having the hardware configuration of the base station device BS.

The base station device BS includes a CPU 201, a storage medium interface unit 202, a storage medium 203, an input unit 204, an output unit 205, a read only memory (ROM) 206, a random access memory (RAM) 207, an auxiliary storage unit 208, and a network interface unit 209. The CPU 201, the storage medium interface unit 202, the input unit 204, the output unit 205, the ROM 206, the RAM 207, the auxiliary storage unit 208, and the network interface unit 209 are connected to each other through a bus.

Meanwhile, the CPU 201 as used herein indicates a processor in general, and includes not only a device called a so-called CPU in a narrow sense, but also, for example, a GPU, a DSP or the like. In addition, the CPU 201 as used herein may be realized by combining a plurality of processors of the same or different kind without being limited to being realized by one processor.

The CPU 201 controls the base station device BS by reading out and executing programs which are stored by the auxiliary storage unit 208, the ROM 206 and the RAM 207, reading out various types of data which are stored by the auxiliary storage unit 208, the ROM 206 and the RAM 207, and writing various types of data in the auxiliary storage unit 208 and the RAM 207. In addition, the CPU 201 reads out various types of data which are stored by the storage medium 203 through the storage medium interface unit 202, and writes various types of data in the storage medium 203. The storage medium 203 is a portable storage medium such as a magnetooptic disc, a flexible disk, or a flash memory, and stores various types of data.

The storage medium interface unit 202 is an interface that performs reading and writing of the storage medium 203.

The input unit 204 is an input device such as a mouse, a keyboard, a touch panel, a sound volume adjustment button, a power button, a setting button, or an infrared reception unit.

The output unit 205 is an output device such as a display unit or a speaker.

The ROM 206 and the RAM 207 store programs or various types of data for bringing each functional unit of the base station device BS into operation.

The auxiliary storage unit 208 is a hard disk drive, a flash memory or the like, and stores programs or various types of data for bringing each functional unit of the base station device BS into operation.

The network interface unit 209 has a communication interface, and is connected to a network NW in a wired or wireless manner. Specifically, the network interface unit 209 includes, for example, a wireless communication interface (not shown) for performing wireless communication with a terminal device and a cable communication interface (not shown) for performing cable communication with a management device or another base station device. The wireless communication interface and the cable communication interface are connected to the network NW.

For example, the communication unit 30 in the functional configuration of the movement source base station device BS1 in FIG. 4 and the communication unit 40 in the functional configuration of the movement destination base station device BS2 in FIG. 5 correspond to the network interface unit 209 in the hardware configuration shown in FIG. 6. In addition, for example, the control unit 31 in the functional configuration of the movement source base station device BS1 in FIG. 4 and the control unit 41 in the functional configuration of the movement destination base station device BS2 correspond to the CPU 201 in the hardware configuration shown in FIG. 6. In addition, for example, the terminal information storage unit 42 in the functional configuration of the movement destination base station device BS2 in FIG. 4 corresponds to the ROM 206, the RAM 207 or the auxiliary storage unit 208 in the hardware configuration shown in FIG. 6, or any combination thereof.

Next, a flow chart illustrating an example of the first-type handover process of the movement source base station device BS1 will be described.

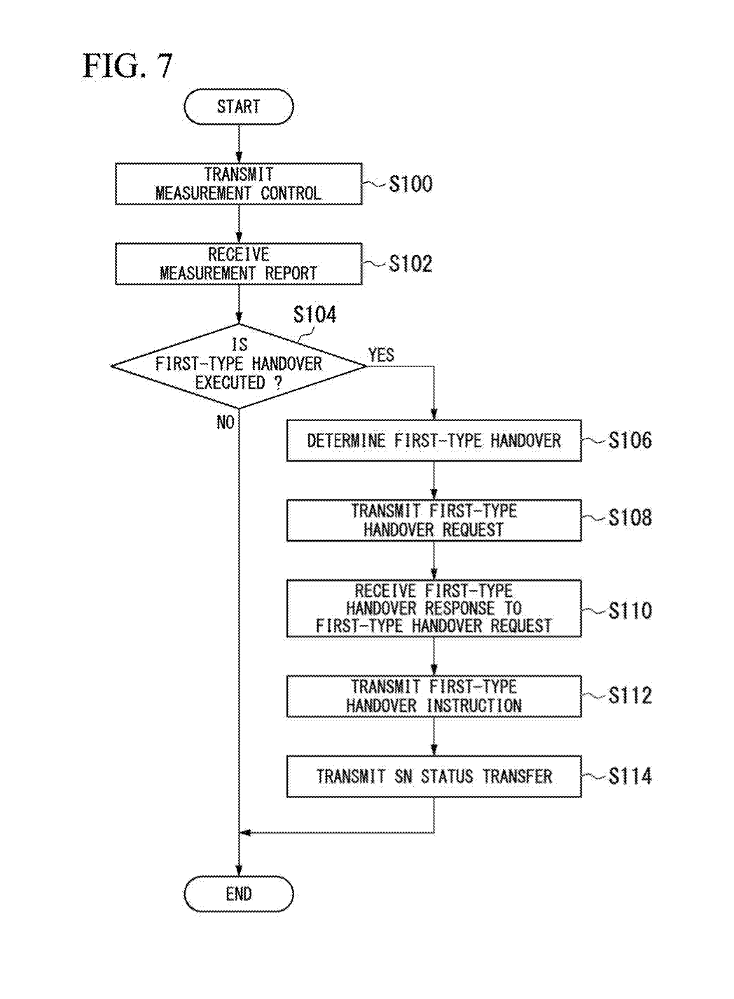

FIG. 7 is a flow chart illustrating an example of a first-type handover process of the movement source base station device BS1 according to the first embodiment.

In step S100, the movement source base station device BS1 transmits Measurement Control to the terminal device UE1.

In step S102, the movement source base station device BS1 receives Measurement Report, performed by the terminal device UE1 having received Measurement Control, from the terminal device UE1.

In step S104, the movement source base station device BS1 refers to information of a terminal device relating to handover included in Measurement Report, and decides whether the first-type handover is to be executed. In a case where the information of a terminal device relating to handover is information indicating an instruction for the execution of the first-type handover (step S104; YES), the movement source base station device BS1 executes the process of step S106. On the other hand, in a case where the information of a terminal device relating to handover is information indicating an instruction for no execution of the first-type handover (step S104; NO), the movement source base station device BS1 terminates the first-type handover process.

In step S106, the movement source base station device BS1 determines whether the first-type handover is to be performed by the terminal device UE1 based on a communication quality for each base station device BS (candidate base station device BS) of a peripheral cell included in Measurement Report and a communication quality between a host device and the terminal device UE1. In a case where the movement source base station device BS1 determines that the first-type handover is not to be performed by the terminal device UE1, the movement source base station device BS1 terminates the first-type handover process. On the other hand, in a case where it is determined that the first-type handover is performed, the movement source base station device BS1 executes the process of step S108.

In step S108, the movement source base station device BS1 transmits the first-type handover request to the movement destination base station device BS2.

In step S110, the movement source base station device BS1 receives a handover response to the first-type handover request.

In step S112, the movement source base station device BS1 transmits the first-type handover instruction to the terminal device UE1.

In step S114, the movement source base station device BS1 transmits SN Status Transfer to the movement destination base station device BS2.

The first-type handover process is then terminated.

Next, a sequence illustrating an example of the first-type handover process according to the present embodiment will be described.

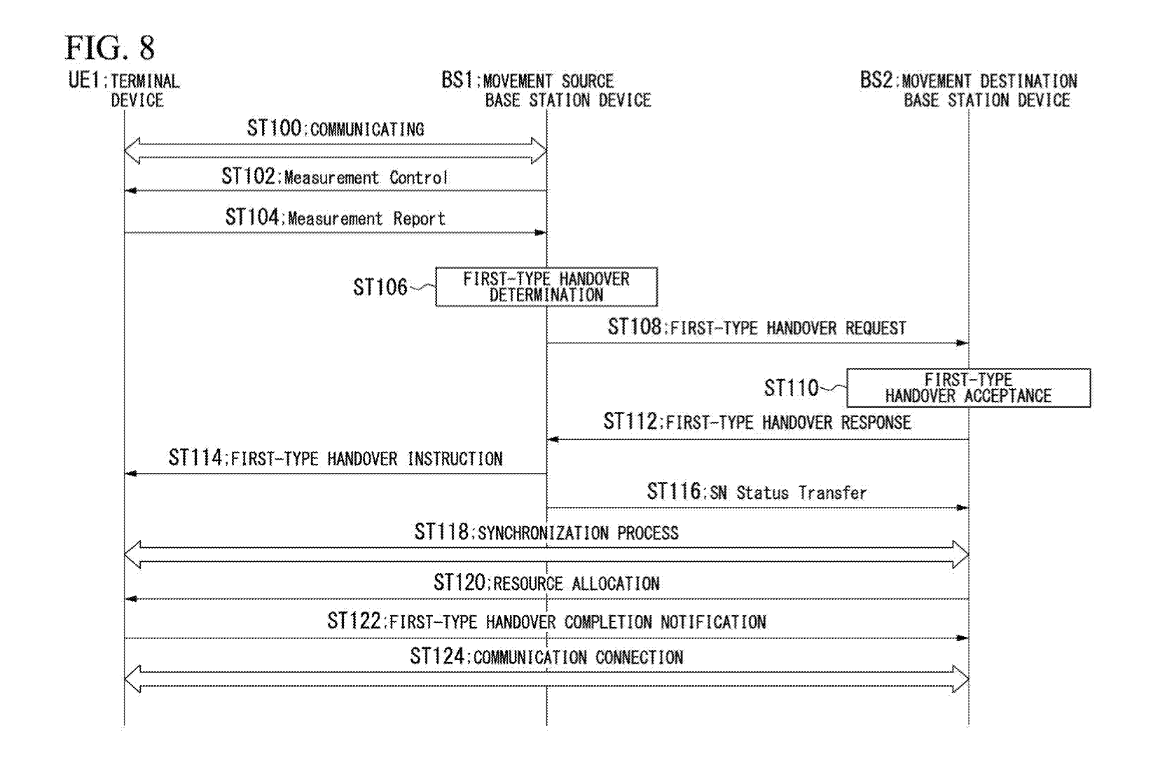

FIG. 8 is a sequence diagram illustrating an example of the first-type handover process according to the first embodiment of the present invention.

In step ST100, the terminal device UE1 communicates with the movement source base station device BS1.

In step ST102, the movement source base station device BS1 transmits Measurement Control indicating an instruction for the measurement of a communication quality to the terminal device UE1.

In step ST104, the terminal device measures a communication quality, and transmits Measurement Report including a measurement result and information of a terminal device relating to handover to the movement source base station device BS1.

In step ST106, the movement source base station device BS1 determines whether the first-type handover is to be performed by the terminal device UE1 based on the information of a terminal device relating to handover included in Measurement Report, a communication quality for each base station device BS (candidate base station device BS) of a peripheral cell, and a communication quality between a host device and the terminal device UE1.

In step ST108, the movement source base station device BS1 generates a first-type handover request indicating a request for the first-type handover to the movement destination base station device BS2. The request unit 312 transmits the generated first-type handover request to the movement destination base station device BS2.

In step ST110, in a case where the first-type handover request is received from the movement source base station device BS1, the movement destination base station device BS2 executes the first-type handover acceptance process.

In step ST112, in a case where the first-type handover acceptance process is completed, the movement destination base station device BS2 transmits the first-type handover response, as a response to the first-type handover request, to the movement source base station device BS1.

In step ST114, the movement source base station device BS1 generates a first-type handover instruction (instruction information) indicting an instruction for handover of the terminal device UE1 to the movement destination base station device BS2. The movement source base station device BS1 transmits the generated first-type handover instruction to the terminal device UE1.

In step ST116, the movement source base station device BS1 transmits SN Status Transfer, as information indicating the status of transmission and reception of data to and from the terminal device UE1, to the movement destination base station device BS2.

In step ST118, the terminal device UE1 is connected to the movement destination base station device BS2, and starts a synchronization process with the movement destination base station device BS2.

In step ST120, the movement destination base station device BS2 notifies the terminal device UE1 of radio resources allocated to the terminal device UE1 as resource allocation information.

In step ST122, the terminal device UE1 generates a first-type handover completion notification indicating that the first-type handover process is completed. The terminal device UE1 transmits the generated first-type handover completion notification to the movement destination base station device BS2.

In step ST124, in a case where the first-type handover completion notification is received from the terminal device UE1, the movement destination base station device BS2 is connected to the terminal device UE1, and communicates with the terminal device.

In this manner, the terminal device UE1 according to the first embodiment is the terminal device UE1 that communicates with the movement source base station device BS1, and includes the transmission unit 112 that transmits the measurement result relating to handover and the information of a terminal device relating to handover to the movement source base station device BS1, the reception unit 111 that receives the instruction information (handover instruction) from the movement source base station device BS1, and the connection unit 123 that is connected to the movement destination base station device BS2 based on the instruction information.

In addition, the information of a terminal device relating to handover is information indicating whether handover is to be performed (for example, information indicating an instruction for whether the first-type handover is executed).

Thereby, since unnecessary radio resources are not secured during handover, the terminal device UE1 can effectively utilize radio resources. In addition, since the terminal device UE1 can select whether to execute the first-type handover by itself, the terminal device can effectively utilize radio resources in a wireless communication system.

(Second Embodiment)

Next, a second embodiment will be described. In the second embodiment, an example in a case where second-type handover is performed instead of the first-type handover will be described. Here, in the second embodiment, a description will be given with focus on differences from the first embodiment.

First, the functional configuration of the terminal device UE1 will be described.

The functional configuration of the terminal device UE1 according to the second embodiment is the same as the functional configuration of the terminal device UE1 according to the first embodiment, and thus is not shown in the drawings. A description will be given with focus on differences from the functional configuration of the terminal device UE1 according to the second embodiment.

In a case where a measurement result is input from the measurement unit 120, and a communication quality (measured value) between a host device and a movement source base station device BS1A exceeds a first threshold, the report generation unit 121 generates Measurement Report by associating identification information for identifying the base station device BS of a peripheral cell with the communication quality of the base station device BS. Measurement Report includes information of a terminal device relating to handover indicating a desired handover (also referred to as, for example, second-type handover, or Conditional Handover) (for example, information (such as a flag) indicating whether the second-type handover is executed). The information of a terminal device relating to handover is also referred to as second information. The second information is also referred to as connection switching information relating to connection switching to another base station device or connection switching means information to another base station device. The report generation unit 121 transmits the generated Measurement Report to the movement source base station device BS1A through the transmission unit 112.

In a case where a second-type handover instruction (CHO instruction, instruction information) indicating an instruction for the second-type handover from the movement source base station device BS1A to another base station device BS (for example, a movement destination base station device BS2A) is received from the movement source base station device BS1A through the reception unit 111, and a communication quality between a host device and the movement source base station device BS1A exceeds a second threshold, the connection unit 123 is connected to the movement destination base station device BS2A, and starts a synchronization process with the movement destination base station device BS2A. The second-type handover instruction includes resource allocation information of radio resources reserved in the terminal device UE1. The connection unit 123 outputs a signal indicating that the synchronization process has started to the information generation unit 124.

In a case where a signal indicating that the setting of the resources is completed is input from the resource management unit 125, the notification generation unit 126 generates a second-type handover completion notification (CHO completion notification) indicating that the second-type handover process is completed. The notification generation unit 126 transmits the generated second-type handover completion notification (CHO completion notification) to the movement destination base station device BS2A through the transmission unit 112.

Next, the configuration of the movement source base station device BS1A will be described.

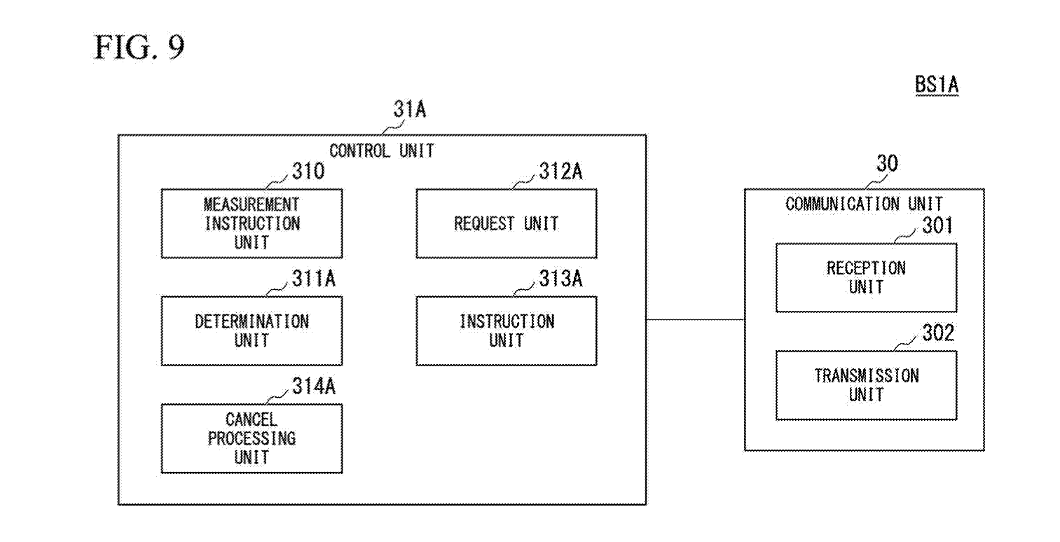

FIG. 9 is a schematic block diagram illustrating an example of a functional configuration of the movement source base station device BS1A according to the second embodiment.

The movement source base station device BS1A is configured to include a communication unit 30 and a control unit 31A.

The communication unit 30 is configured to include a reception unit 301 and a transmission unit 302. The control unit 31A is configured to include a measurement instruction unit 310, a determination unit 311A, a request unit 312A, an instruction unit 313A, and a cancel processing unit 314A.

The control unit 31A controls the movement source base station device BS1A.

In a case where Measurement Report indicating the measurement result of the communication quality is received from the terminal device UE1 through the reception unit 301, the determination unit 311A determines whether the second-type handover is to be performed by the terminal device UE1 based on information of a terminal device relating to handover included in Measurement Report, a communication quality for each base station device BS (candidate base station device BS) of a peripheral cell, and a communication quality between a host device and the terminal device UE1. The determination unit 311A determines that, for example, a desired handover indicated by the information of a terminal device relating to handover is the second-type handover, and determines candidate base station devices BS serving as one or a plurality of movement destination candidates based on the communication quality. In a case where the second-type handover of the terminal device UE1 is determined, the determination unit 311A outputs a signal indicating the determination to the request unit 312A.

In a case where the signal indicating the determination is input from the determination unit 311A, the request unit 312A generates a second-type handover request indicating a request for the second-type handover to one or a plurality of candidate base station devices BS (for example, the movement destination base station device BS2A or a candidate base station device BS3). The request unit 312A transmits the generated second-type handover request to one or a plurality of candidate base station devices BS through the transmission unit 302.

In the present embodiment, a case where the number of candidate base station devices is two will be described. In the following description, one of these candidate base station devices is referred to as the movement destination base station device BS2A, and the other candidate base station device is referred to as the candidate base station device BS3, but there is no limitation thereto.

In a case where a second-type handover response (CHO response) is received as a response to the second-type handover request transmitted by the request unit 312A from the movement destination base station device BS2A and the candidate base station device BS3 through the reception unit 301, the instruction unit 313A generates a second-type handover instruction (instruction information) indicating an instruction for the second-type handover to the movement destination base station device BS2A. The second-type handover response includes resource allocation information of radio resources reserved in the terminal device UE1. The instruction unit 313A transmits the generated second-type handover instruction to the terminal device UE1 through the transmission unit 302. The second-type handover instruction includes the resource allocation information of radio resources reserved in the terminal device UE1 which is included in the second-type handover response.

In a case where a second-type handover completion report (CHO completion report) is received from the movement destination base station device BS2A through the reception unit 301, the cancel processing unit 314A transmits a second-type handover cancel notification to the candidate base station device BS3 through the transmission unit 302. The second-type handover cancel notification is a notification indicating an instruction for a cancel process such as opening of radio resources of the terminal device UE1 reserved by the candidate base station device BS3.

In addition, in a case where a second-type handover cancel response indicating that the cancel process is completed is received from the candidate base station device BS3 through the reception unit 301, the cancel processing unit 314A transmits SN Status Transfer, as information indicating the status of transmission and reception of data between the terminal device UE1 and the movement source base station device BS1A, to the movement destination base station device BS2A through the transmission unit 302.

Next, the functional configuration of the movement destination base station device BS2A will be described. Meanwhile, since the functional configuration of the candidate base station device BS3 is the same as the functional configuration of the movement destination base station device BS2A, the description thereof will be quoted, and thus the illustration and description thereof will be omitted.

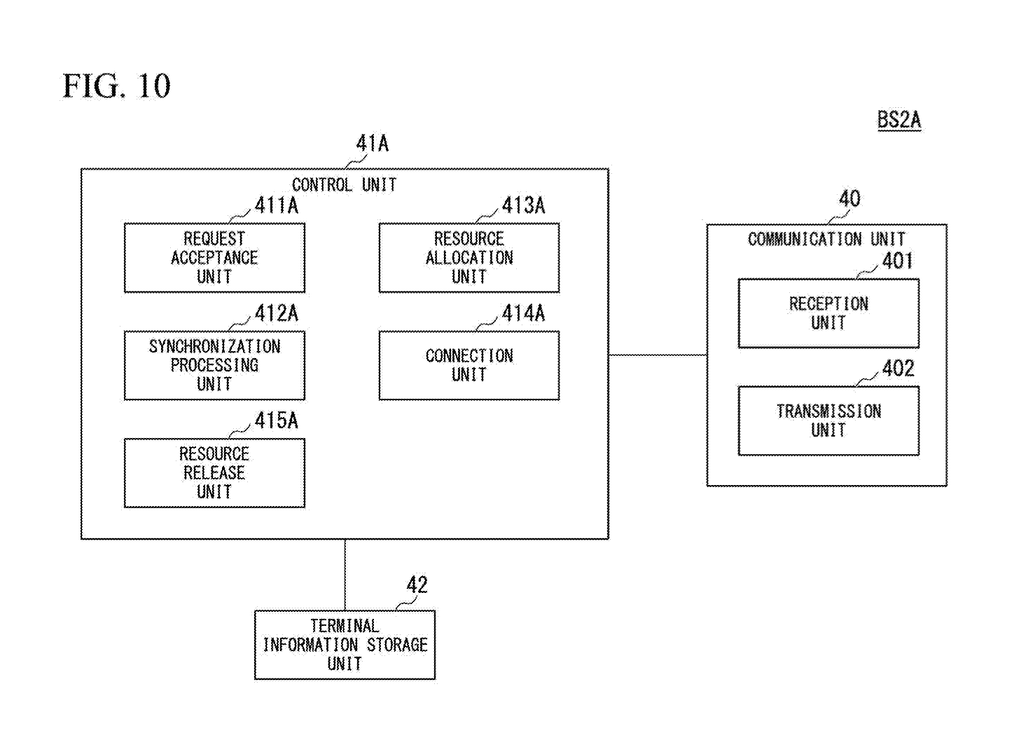

FIG. 10 is a schematic block diagram illustrating an example of a configuration of the movement destination base station device BS2A according to the second embodiment.

The movement destination base station device BS2A is configured to include a communication unit 40 and a control unit 41A.

The communication unit 40 is configured to include a reception unit 401 and a transmission unit 402. The control unit 41A is configured to include a request acceptance unit 411A, a synchronization processing unit 412A, a resource allocation unit 413A, a connection unit 414A, and a resource release unit 415A.

The control unit 41A controls the movement destination base station device BS2A.

In a case where the second-type handover request (CHO request) is received from the movement source base station device BS1 through the reception unit 401, the request acceptance unit 411A executes a second-type handover acceptance process (CHO acceptance process). The second-type handover acceptance process is various types of process for operation in a movement destination base station device for handover, and is, for example, various types of negotiation between the movement source base station device BS1A and the movement destination base station device BS2A, or the like. In a case where the second-type handover acceptance process is completed, the request acceptance unit 411A transmits the second-type handover response (CHO response), as a response to the second-type handover request, to the movement source base station device BS1A through the transmission unit 402. The second-type handover response includes resource allocation information of radio resources reserved in the terminal device UE1.

In a case where there is connection using radio resources reserved from the terminal device UE1, the synchronization processing unit 412A executes a connection process.

In a case where the second-type handover request is received from the movement source base station device BS1A through the reception unit 401, the resource allocation unit 413A reserves radio resources allocated to the terminal device UE1. The resource allocation unit 413A outputs the reserved radio resources, as resource allocation information, to the request acceptance unit 411A. In addition, the resource allocation unit 413A stores the resource allocation information of the terminal device UE1 and identification information of the terminal device UE1 in the terminal information storage unit 42 in association with each other.

In a case where the second-type handover completion notification (CHO completion notification) indicating that the second-type handover process is completed is received from the terminal device UE1 through the reception unit 401, the connection unit 414A transmits the second-type handover completion notification (CHO completion notification) to the movement source base station device BS1A through the transmission unit 402.

In addition, in a case where SN Status Transfer is received as information indicating the status of transmission and reception of data between the terminal device UE1 and the movement source base station device BS1A from the movement source base station device BS through the reception unit 301, the connection unit 414A is connected to the terminal device UE1, and communicates with the terminal device.

Next, a flow chart illustrating an example of the second-type handover process of the movement source base station device BS1A will be described.

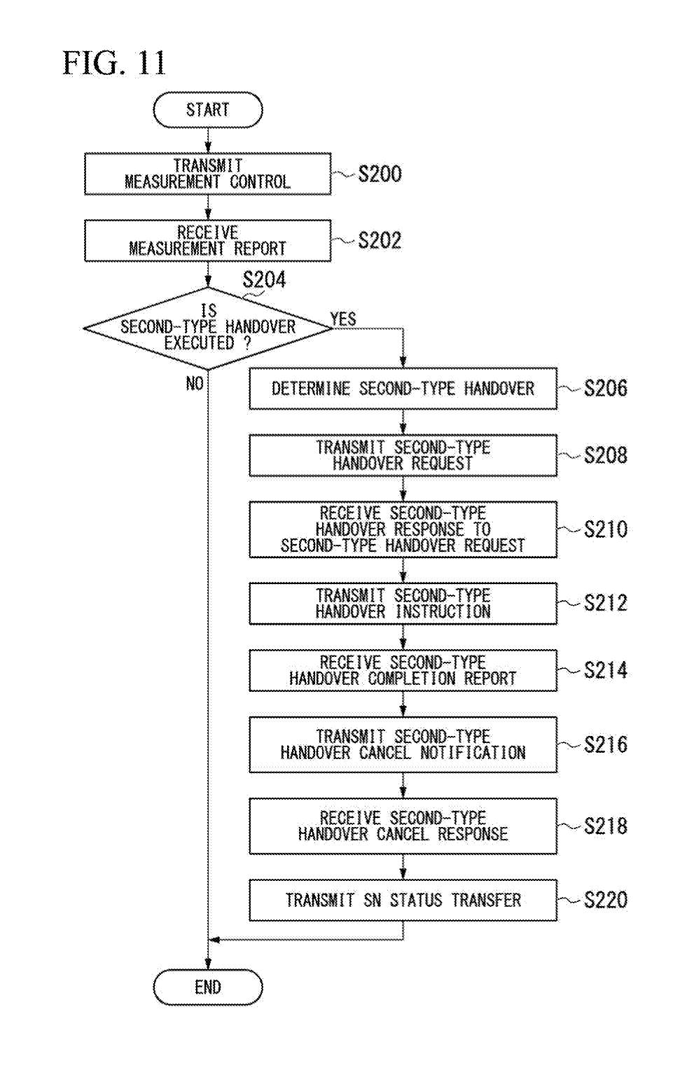

FIG. 11 is a flow chart illustrating an example of the second-type handover process of the movement source base station device BS1A according to the second embodiment.

In step S200, the movement source base station device BS transmits Measurement Control to the terminal device UE1.

In step S202, the movement source base station device BS1A receives Measurement Report, performed by the terminal device UE1 having received Measurement Control, from the terminal device UE1.

In step S204, the movement source base station device BS1A refers to information of a terminal device relating to handover included in Measurement Report, and decides whether the second-type handover (CHO) is executed. In a case where the information of a terminal device relating to handover is information indicating an instruction for the execution of the second-type handover (step S204; YES), the movement source base station device BS1A executes the process of step S206. On the other hand, in a case where the information of a terminal device relating to handover is information indicating an instruction for no execution of the second-type handover (step S204; NO), the movement source base station device BS1A terminates the second-type handover process.

In step S206, the movement source base station device BS1A determines whether the second-type handover is to be performed by the terminal device UE1 based on a communication quality for each base station device BS (candidate base station device BS) of a peripheral cell included in Measurement Report and a communication quality between a host device and the terminal device UE1. In a case where the movement source base station device BS1A determines that the second-type handover is not performed by the terminal device UE1, the movement source base station device BS1A terminates the second-type handover process. On the other hand, in a case where it is determined that the second-type handover is performed, the movement source base station device BS1A executes the process of step S208.

In step S208, the movement source base station device BS1A transmits the second-type handover request to the movement destination base station device BS2A and the candidate base station device BS3.

In step S210, the movement source base station device BS1A receives a second-type handover response to the second-type handover request from the movement destination base station device BS2A and the candidate base station device BS3.

In step S212, the movement source base station device BS1A transmits the second-type handover instruction (CHO instruction), including resource allocation information included in the second-type handover response of the movement destination base station device BS2A determined as a movement destination base station device, to the terminal device UE1.

In step S214, the movement source base station device BS1A receives a second-type handover (CHO) completion report from the movement destination base station device BS2A.

In step S216, the movement source base station device BS1A transmits the second-type handover cancel notification to the candidate base station device BS3.

In step S218, the movement source base station device BS1A receives the second-type handover cancel response from the candidate base station device BS3.

In step S220, the movement source base station device BS1A transmits SN Status Transfer to the movement destination base station device BS2A.

The second-type handover process is then terminated.

In step S212, in a case where the second-type handover instruction is transmitted to the terminal device UE1 and then the second-type handover completion report is not received from any base station devices after a predetermined time, the movement source base station device BS1A may terminate (cancel) the second-type handover process.

In this manner, in the second-type handover, in a case where the movement source base station device BS1A determines the execution of handover, a plurality of candidate base station devices BS including the movement destination base station device BS2A secure radio resources in advance. Therefore, in a case where the first-type handover and the second-type handover are compared with each other, in the second-type handover, it is possible to shorten a time relating to the handover process, and to increase the success rate of handover.

Next, a sequence illustrating an example of the second-type handover process according to the present embodiment will be described.

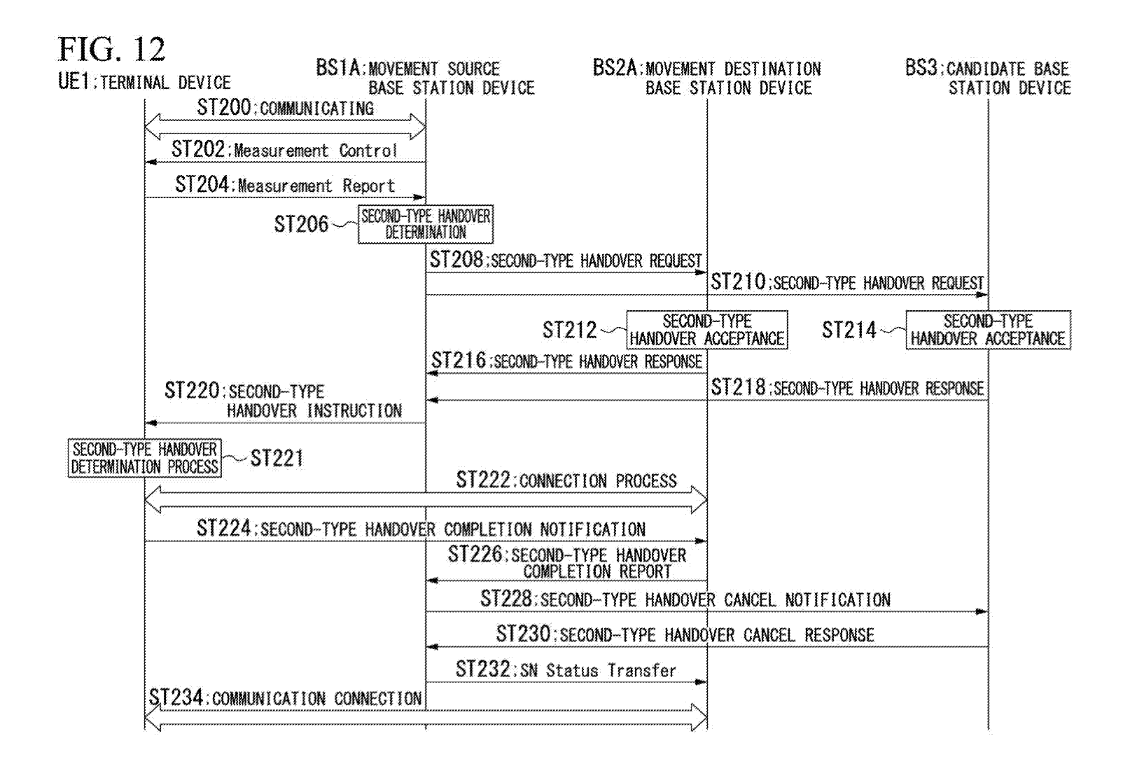

FIG. 12 is a sequence diagram illustrating an example of the second-type handover process according to the second embodiment of the present invention.

In step ST200, the terminal device UE1 communicates with the movement source base station device BS1A.

In step ST202, the movement source base station device BS1A transmits Measurement Control indicating an instruction for the measurement of a communication quality to the terminal device UE1.

In step ST204, the terminal device UE1 measures a communication quality, and transmits Measurement Report including a measurement result and information of a terminal device relating to handover to the movement source base station device BS1A.

In step ST206, the movement source base station device BS1A confirms whether candidate base station devices on which handover is performed by the terminal device UE1 are present based on the information of a terminal device relating to handover included in Measurement Report, a communication quality for each base station device BS (candidate base station device BS) of a peripheral cell, and a communication quality between a host device and the terminal device UE1. In a case where candidate base station devices are present, the movement source base station device BS1A selects one or a plurality of candidate base station devices, and determines whether the second-type handover is performed by the terminal device UE1. In this example, candidate base station devices on which handover is performed by the terminal device UE1 are two base station devices of the movement destination base station device BS2A and the candidate base station device BS3.

In step ST208, the movement source base station device BS1A generates a second-type handover request indicating a request for the second-type handover to the movement destination base station device BS2A. The movement source base station device BS1A transmits the generated second-type handover request to the movement destination base station device BS2A.

In step ST210, the movement source base station device BS1A generates a second-type handover request indicating a request for the second-type handover to the candidate base station device BS3. The movement source base station device BS1A transmits the generated second-type handover request to the candidate base station device BS3.

In step ST212, the movement destination base station device BS2A executes the second-type handover acceptance process. The second-type handover acceptance process includes a process of allocating radio resources to the terminal device UE1, a negotiation relating to the second-type handover, or the like.

In step ST214, the candidate base station device BS3 executes the second-type handover acceptance process. The second-type handover acceptance process includes a process of allocating radio resources to the terminal device UE1, a negotiation relating to the second-type handover, or the like.

In step ST216, in a case where the second-type handover acceptance process is completed, the movement destination base station device BS2A transmits the second-type handover response as a response to the second-type handover request to the movement source base station device BS1A. This second-type handover response includes the resource allocation information of the terminal device UE1.

In step ST218, in a case where the second-type handover acceptance process is completed, the candidate base station device BS3 transmits the second-type handover response as a response to the second-type handover request to the movement source base station device BS1A. This second-type handover response includes the resource allocation information of the terminal device UE1.

In step ST220, the movement source base station device BS1A generates a second-type handover instruction (instruction information) including information of the movement destination base station device BS2A serving as a movement destination candidate for the terminal device UE1 and information of the candidate base station device BS3 serving as a movement destination candidate for the terminal device UE1. The movement source base station device BS1A transmits the generated second-type handover instruction to the terminal device UE1. This second-type handover instruction includes the resource allocation information of the terminal device UE1 based on the movement destination base station device BS2A and the resource allocation information of the terminal device UE1 based on the candidate base station device BS3.

In step ST221, in a case where the second-type handover instruction is received from the movement source base station device BS1A, the terminal device UE1 executes the second-type handover determination process relating to the second-type handover. The second-type handover determination process includes a process of determining whether handover to a candidate base station device is performed, or a process of determining whether handover to any of a plurality of candidate base station devices (for example, the movement destination base station device BS2A and the candidate base station device BS3) is performed in a case where handover is performed. More specifically, in a case where the second-type handover instruction is received, the terminal device UE1 determines whether to perform handover depending on whether a predetermined reference is satisfied. For example, in a case where any of communication qualities (for example, reception qualities) between the candidate base station devices BS (the movement destination base station device BS2A and the candidate base station device BS3) and the terminal device UE1 is better than a communication quality (for example, reception quality) between the movement source base station device BS1A and the terminal device UE1, that is, a case where a communication quality after handover to any of the candidate base station devices BS is further improved than a communication quality before handover is performed, the terminal device UE1 decides that a predetermined reference is satisfied, and determines the execution of handover.

In addition, the terminal device UE1 determines whether to perform handover to any of a plurality of candidate base station devices. Specifically, the terminal device UE1 determines a base station device having a best communication quality after handover of each of a plurality of candidate base station devices as a movement destination base station device. The shown example is an example in a case where the terminal device UE1 determines the movement destination base station device BS2A as a movement destination base station device.

In step ST222, the terminal device UE1 is connected to the movement destination base station device BS2A using radio resources shown in the resource allocation information included in the second-type handover instruction (CHO instruction), and performs a connection process.

In step ST224, in a case where a process of connection to the movement destination base station device BS2A is completed, the terminal device UE1 transmits the second-type handover completion notification to the movement destination base station device BS2A.

In step ST226, the movement destination base station device BS2A transmits the second-type handover completion notification indicating that the process of connection to the terminal device UE1 is completed to the movement source base station device BS1.

In step ST228, the movement source base station device BS1A transmits the CHO cancel notification candidate base station device BS3.

In step ST230, the movement source base station device BS1A receives the CHO cancel response from the candidate base station device BS3.

In step ST232, the movement source base station device BS1A transmits SN Status Transfer, as information indicating the status of transmission and reception of data to and from the terminal device UE1, to the movement destination base station device BS2A.

In step ST234, the movement destination base station device BS2A is connected to the terminal device UE1, and communicates with the terminal device.

Meanwhile, in step ST221, in a case where a predetermined time has elapsed after the reception of the second-type handover instruction (CHO instruction) in step ST220, the terminal device UE1 may cancel the second-type handover process.

In this manner, the terminal device UE1 according to the second embodiment is the terminal device UE1 that communicates with the movement source base station device BS1A, and includes the transmission unit 112 that transmits the measurement result relating to handover and the information of a terminal device relating to handover to the movement source base station device BS1A, the reception unit 111 that receives the instruction information (second-type handover instruction) from the movement source base station device BS1A, and the connection unit 123 that is connected to the movement destination base station device BS2A based on the instruction information.

In addition, the information of a terminal device relating to handover is information indicating whether handover is to be performed (for example, information indicating an instruction for whether the second-type handover is executed).

Thereby, since unnecessary radio resources are not secured during handover, the terminal device UE1 can effectively utilize radio resources. In addition, since the terminal device UE1 can select whether to execute the second-type handover by itself, the terminal device can effectively utilize radio resources in a wireless communication system.

(Third Embodiment)

Next, a third embodiment will be described. In the third embodiment, an example in a case where the first-type handover and the second-type handover are performed will be described. Here, in the third embodiment, a description will be given with focus on differences from the first embodiment and the second embodiment.

First, a functional configuration of a terminal device UE1B will be described.

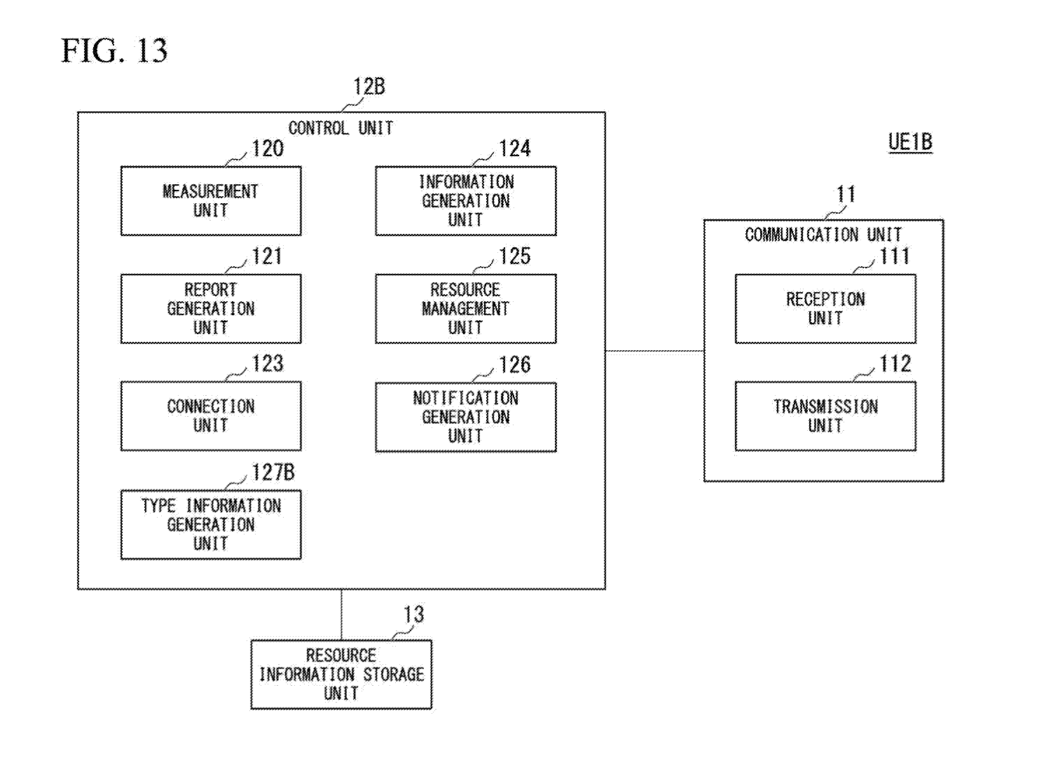

FIG. 13 is a schematic block diagram illustrating an example of a functional configuration of the terminal device UE1B according to the third embodiment.

The terminal device UE1B is configured to include a communication unit 11, a control unit 12B, and a resource information storage unit 13.

The communication unit 11 is configured to include a reception unit 111 and a transmission unit 112. The control unit 12B is configured to include a measurement unit 120, a report generation unit 121, a connection unit 123, an information generation unit 124, a resource management unit 125, a notification generation unit 126, and a type information generation unit 127B.

Here, the terminal device UE1B according to the third embodiment is assumed to have each function of the terminal device UE1 according to the first embodiment and the terminal device UE1 according to the second embodiment.

The type information generation unit 127B generates information of a terminal device relating to handover (also referred to as connection switching information relating to connection switching to another base station device, or connection switching means information indicating which of two or more means (the first-type handover, the second-type handover, and the like) of connection switching to another base station device is used) including at least any of information (first information) indicating whether the first-type handover is executed and information (second information) indicating whether the second-type handover is executed. That is, the information of a terminal device relating to handover includes any of information indicating an instruction for the execution of the first-type handover, information indicating an instruction for no execution of the first-type handover, information indicating an instruction for the execution of the second-type handover, and information indicating an instruction for no execution of the second-type handover.

The type information generation unit 127B outputs the generated information of a terminal device relating to handover to the report generation unit 121.

Next, a functional configuration of a movement source base station device BS1B will be described.

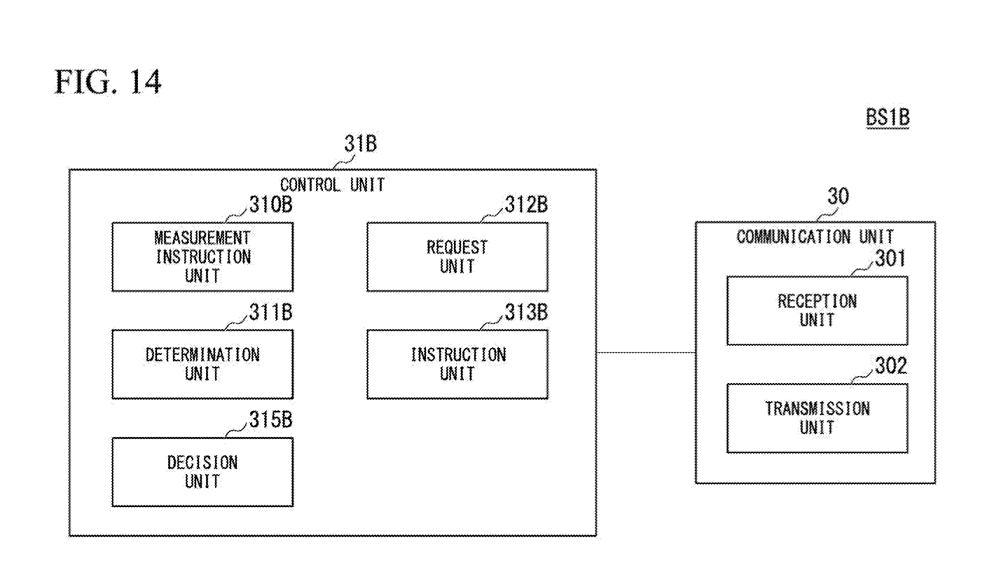

FIG. 14 is a schematic block diagram illustrating an example of a functional configuration of the movement source base station device BS1B according to the third embodiment.

The movement source base station device BS1B is configured to include a communication unit 30 and a control unit 31B.

The communication unit 30 is configured to include a reception unit 301 and a transmission unit 302. The control unit 31B is configured to include a measurement instruction unit 310B, a determination unit 311B, a request unit 312B, an instruction unit 313B, and a decision unit 315B.

Here, the movement source base station device BS1B according to the third embodiment is assumed to have each function of the movement source base station device BS1 according to the first embodiment and the movement source base station device BS1A according to the second embodiment.

The decision unit 315B decides whether the information of a terminal device relating to handover included in Measurement Report received from the terminal device UE1B is information indicating an instruction for the execution of any handover. In addition, the decision unit 315B performs switching of the movement source base station device BS1B functioning as the movement source base station device BS1 according to the first embodiment or functioning as the movement source base station device BS1A according to the second embodiment based on the decision result.

Next, the functional configurations of the movement destination base station device BS2B and the candidate base station device BS will be described.

The functional configurations of the movement destination base station device BS2B and the candidate base station device BS according to the present embodiment are assumed to have each function of the movement destination base station device BS2 according to the first embodiment and the movement destination base station device BS2A according to the second embodiment. It is assumed that switching of the movement destination base station device BS2AB functioning as any of the movement destination base station device BS2 and the movement destination base station device BS2A depending on whether a handover request received from the movement source base station device BS1B is the first-type handover request or the second-type handover request is performed.

Next, a flow chart illustrating an example of a handover process of the movement source base station device BS1B will be described.

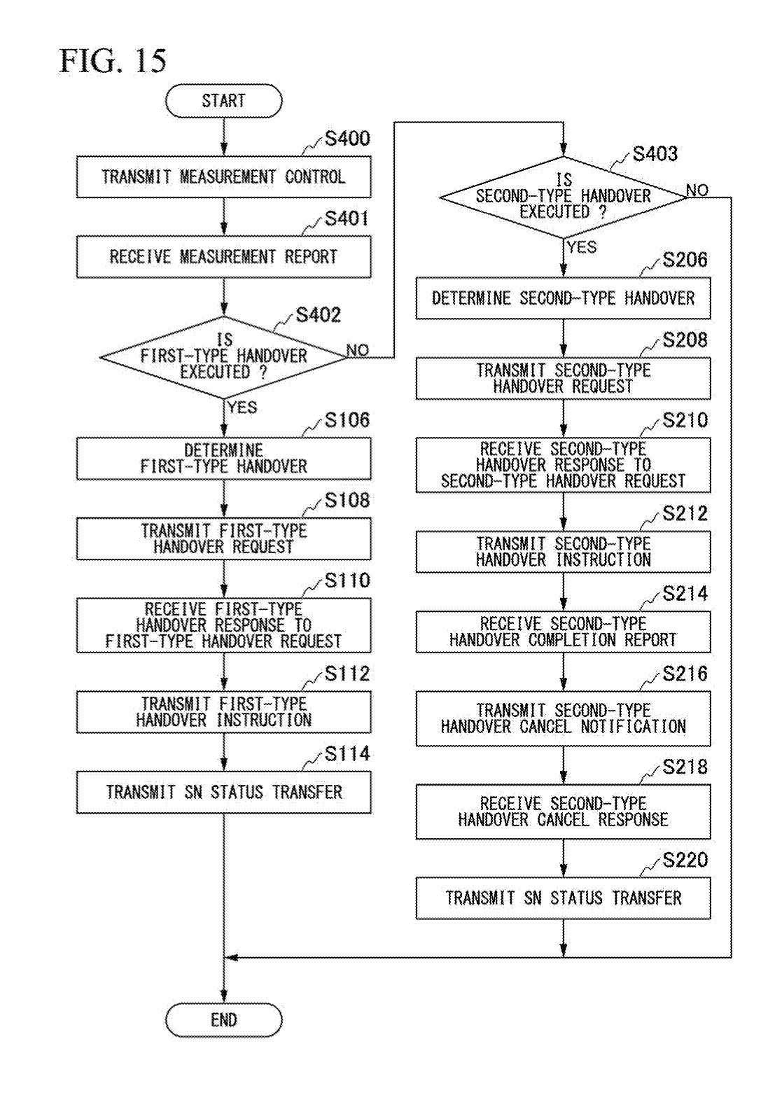

FIG. 15 is a flow chart illustrating an example of a handover process of the movement source base station device BS1B according to the third embodiment.

In step S400, the movement source base station device BS1B transmits Measurement Control to the terminal device UE1.

In step S401, the movement source base station device BS1B receives Measurement Report, performed by the terminal device UE1B having received Measurement Control, from the terminal device UE1B.

In step S402, the movement source base station device BS1B decides whether the first-type handover is executed. Specifically, the movement source base station device BS1B refers to the information of a terminal device relating to handover included in Measurement Report, and decides whether the first-type handover is executed based on whether being information indicating an instruction for whether the first-type handover is executed. In a case where the information of a terminal device relating to handover is information indicating an instruction for the execution of the first-type handover (step S402; YES), the movement source base station device BS1B executes the process of step S106. On the other hand, in a case where the information of a terminal device relating to handover is information indicating an instruction for no execution of the first-type handover, or information indicating an instruction for whether the second-type handover is executed (step S402; NO), the movement source base station device BS1B executes the process of step S403.

Meanwhile, the information of a terminal device relating to handover (connection switching information relating to connection switching to another base station device) may be information indicating whether the first-type handover is executed, or the second-type handover is executed.

In step S403, the movement source base station device BS1B decides whether the second-type handover is executed. Specifically, the movement source base station device BS1B refers to the information of a terminal device relating to handover included in Measurement Report, and decides whether the second-type handover is executed based on whether being information indicating an instruction for whether the second-type handover (CHO) is executed. In a case where the information of a terminal device relating to handover is information indicating an instruction for the execution of the second-type handover (step S403; YES), the movement source base station device BS1B executes the process of step S206. On the other hand, in a case where the information of a terminal device relating to handover is information indicating an instruction for no execution of the second-type handover (step S403; NO), the movement source base station device BS1B terminates the handover process.

The processes of step S106 to step S114 are the same as those in the first embodiment, and thus the description thereof will not be given.

In addition, the processes of step S206 to step S220 are the same as those in the second embodiment, and thus the description thereof will not be given.

In this manner, the terminal device UE1B according to the third embodiment is the terminal device UE1B that communicates with the movement source base station device BS1B, and includes the transmission unit 112 that transmits the measurement result relating to handover and the information of a terminal device relating to handover to the movement source base station device BS1A, the reception unit 111 that receives the instruction information from the movement source base station device BS1B, and the connection unit 123 that is connected to the movement destination base station device BS2A based on the instruction information.

In addition, the information of a terminal device relating to handover is information indicating whether handover is to be performed (for example, information whether the first-type handover is executed, or information indicating an instruction for whether the second-type handover is executed).

Thereby, since unnecessary radio resources are not secured during handover, the terminal device UE1B can effectively utilize radio resources. In addition, since radio resources to be secured in advance can be further reduced than in a case where only the second-type handover is performed, it is possible to effectively utilize radio resources. In addition, in a case where a plurality of terminal devices perform handover all at once, a huge amount of radio resources is secured. However, since switching of any handover can be performed, it is possible to suppress the securing of a temporarily huge amount of radio resources, and to effectively utilize radio resources. In addition, since the terminal device UE1B can select whether to execute any handover by itself, the terminal device can effectively utilize radio resources in a wireless communication system.

### FIRST MODIFICATION EXAMPLE

In a first modification example, another example of the second-type handover process described in the second embodiment will be described.

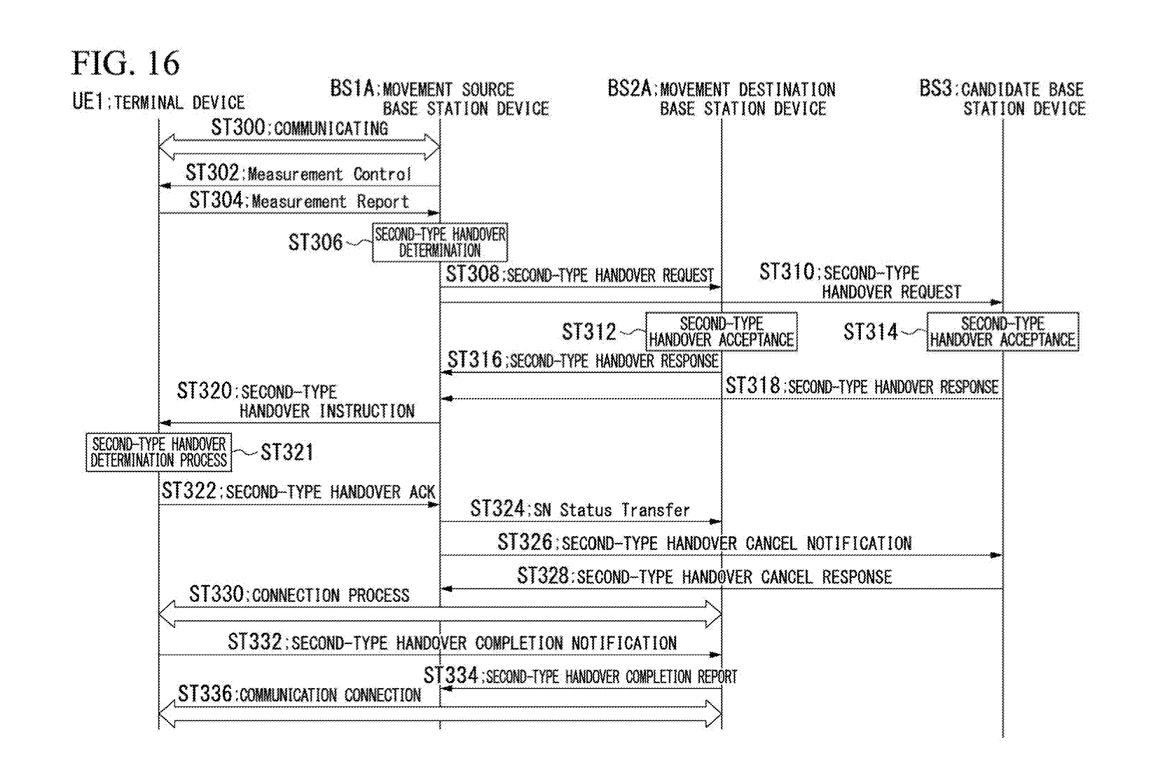

FIG. 16 is a sequence diagram illustrating an example of a second-type handover process according to a modification example of the present invention.

In step ST300, the terminal device UE1 communicates with the movement source base station device BS1A.

In step ST302, the movement source base station device BS1A transmits Measurement Control indicating an instruction for the measurement of a communication quality to the terminal device UE1.

In step ST304, the terminal device UE1 measures a communication quality, and transmits Measurement Report including a measurement result and information of a terminal device relating to handover to the movement source base station device BS1A.

In step ST306, the movement source base station device BS1A confirms whether candidate base station devices on which handover is performed by the terminal device UE1 are present based on the information of a terminal device relating to handover included in Measurement Report, a communication quality for each base station device BS (candidate base station device BS) of a peripheral cell, and a communication quality between a host device and the terminal device UE1. In a case where candidate base station devices are present, the movement source base station device BS1A selects one or a plurality of candidate base station devices, and determines whether the second-type handover is to be performed by the terminal device UE1. In this example, candidate base station devices on which handover is performed by the terminal device UE1 are two base station devices of the movement destination base station device BS2A and the candidate base station device BS3.

In step ST308, the movement source base station device BS1A generates a second-type handover request indicating a request for the second-type handover to the movement destination base station device BS2A. The movement source base station device BS transmits the generated second-type handover request to the movement destination base station device BS2A.

In step ST310, the movement source base station device BS1A generates a second-type handover request indicating a request for the second-type handover to the candidate base station device BS3. The movement source base station device BS1A transmits the generated second-type handover request to the candidate base station device BS3.

In step ST312, the movement destination base station device BS2A executes the second-type handover acceptance process. The second-type handover acceptance process includes a process of allocating radio resources to the terminal device UE1, a negotiation relating to the second-type handover, or the like.

In step ST314, the candidate base station device BS3 executes the second-type handover acceptance process. The second-type handover acceptance process includes a process of allocating radio resources to the terminal device UE1, a negotiation relating to the second-type handover, or the like.

In step ST316, in a case where the second-type handover acceptance process is completed, the movement destination base station device BS2A transmits the second-type handover response as a response to the second-type handover request to the movement source base station device BS1A. This second-type handover response includes the resource allocation information of the terminal device UE1.

In step ST318, in a case where the second-type handover acceptance process is completed, the candidate base station device BS3 transmits the second-type handover response as a response to the second-type handover request to the movement source base station device BS1A. This second-type handover response includes the resource allocation information of the terminal device UE1.

In step ST320, the movement source base station device BS1A generates a second-type handover instruction (instruction information) indicating an instruction for handover of the terminal device UE1 to the movement destination base station device BS2A. The movement source base station device BS1A transmits the generated second-type handover instruction to the terminal device UE1. This second-type handover instruction includes the resource allocation information of the terminal device UE1 based on the movement destination base station device BS2A and the resource allocation information of the terminal device UE1 based on the candidate base station device BS3.

In step ST321, in a case where the second-type handover instruction is received from the movement source base station device BS1A, the terminal device UE1 executes the CHO determination process relating to the second-type handover. The CHO determination process includes a process of determining whether handover to a candidate base station device is performed, or a process of determining whether handover to any of a plurality of candidate base station devices is performed in a case where handover is performed. More specifically, in a case where the second-type handover instruction is received, the terminal device UE1 determines whether to perform handover depending on whether a predetermined reference is satisfied. For example, in a case where the communication quality (for example, reception quality) between the candidate base station devices BS (the movement destination base station device BS2A and the candidate base station device BS3) and the terminal device UE1 is better than the communication quality (for example, reception quality) between the movement source base station device BS1A and the terminal device UE1, that is, a case where a communication quality after handover is further improved than a communication quality before handover is performed, the terminal device UE1 decides that a predetermined reference is satisfied, and determines the execution of handover.

In addition, the terminal device UE1 determines whether to perform handover to any of a plurality of candidate base station devices. Specifically, the terminal device UE1 determines a base station device having a best communication quality after handover of each of a plurality of candidate base station devices as a movement destination base station device. The shown example is an example in a case where the terminal device UE1 determines the movement destination base station device BS2A as a movement destination base station device.

In step S322, the terminal device UE1 transmits second-type handover Ack (CHO Ack) indicating the reception of the second-type handover instruction to the movement source base station device BS1.

In step ST324, the movement source base station device BS1A transmits SN Status Transfer, as information indicating the status of transmission and reception of data to and from the terminal device UE1, to the movement destination base station device BS2A.

In step ST326, the movement source base station device BS1A transmits the second-type handover cancel notification to the candidate base station device BS3.

In step S328, the movement source base station device BS1A receives the second-type handover cancel response from the candidate base station device BS3.

In step ST330, the terminal device UE1 is connected to the movement destination base station device BS2A using radio resources shown in the resource allocation information, and performs a connection process.

In step ST332, in a case where a process of connection to the movement destination base station device BS2A is completed, the terminal device UE1 transmits the second-type handover completion notification to the movement destination base station device BS2A.

In step ST334, the movement destination base station device BS2A transmits the second-type handover completion notification indicating that the process of connection to the terminal device UE1 is completed to the movement source base station device BS1.

In step ST336, the movement destination base station device BS2A is connected to the terminal device UE1, and communicates with the terminal device.

Meanwhile, in step ST321, in a case where a predetermined time has elapsed after the reception of the second-type handover instruction (CHO instruction) in step ST320, the terminal device UE1 may cancel the second-type handover process.

In this manner, it is possible to obtain the same effect as that in the second embodiment.

### SECOND MODIFICATION EXAMPLE

Meanwhile, in each of the embodiments described above, a case where the first-type handover is not executed, a case where the second-type handover is not executed, or a case where neither the first-type handover nor the second-type handover is not executed is present. However, when these handovers are not executed, a reconnection process may be executed.

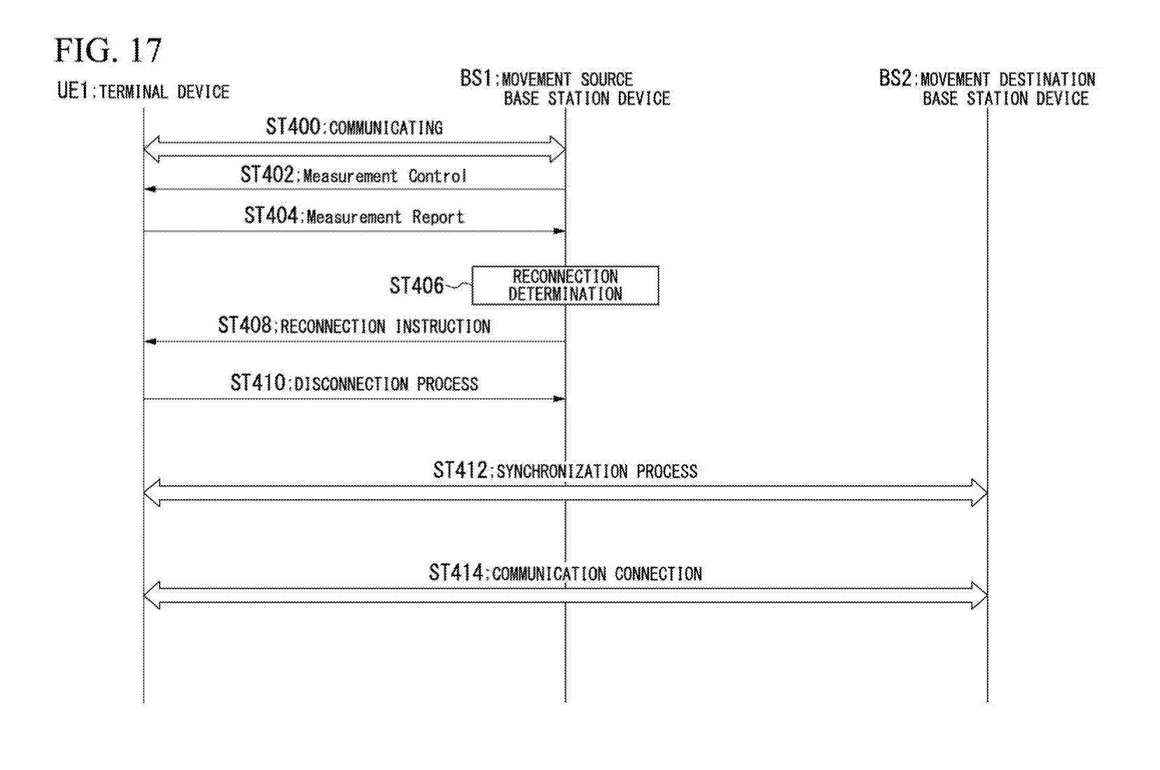

FIG. 17 is a sequence diagram illustrating an example of a reconnection process according to a modification example of the present invention.

In step ST400, the terminal device UE1 communicates with the movement source base station device BS1.

In step ST402, the movement source base station device BS1 transmits Measurement Control indicating an instruction for the measurement of a communication quality to the terminal device UE1.

In step ST404, the terminal device measures a communication quality, and transmits Measurement Report including a measurement result and information of a terminal device relating to handover to the movement source base station device BS1.

In step ST406, the movement source base station device BS1 determines whether reconnection to the terminal device UE1 is performed based on the information of a terminal device relating to handover included in Measurement Report, a communication quality for each base station device BS (candidate base station device BS) of a peripheral cell, and a communication quality between a host device and the terminal device UE1. The information of a terminal device relating to handover may be, for example, information indicating whether reconnection is executed.

In step ST408, the movement source base station device BS1 generates a reconnection instruction (instruction information) for instructing the terminal device UE1 to perform reconnection to the movement destination base station device BS2. The movement source base station device BS1 transmits the generated reconnection instruction to the terminal device UE1.

In step ST410, the terminal device UE1 executes a process of disconnecting communication with the movement source base station device BS1.

In step ST412, in a case where the process of disconnection from the movement source base station device BS1 is completed, the terminal device UE1 confirms the resource allocation information stored by the resource information storage unit 13.

The terminal device UE1 is connected to the movement destination base station device BS2 using radio resources of the movement destination base station device BS2 serving as a base station device which is a reconnection destination, and starts a synchronization process with the movement destination base station device BS2.

In step ST414, in a case where the synchronization process is completed, the terminal device UE1 starts (continues) communication with the movement destination base station device BS2.

In this manner, by reconnection to the movement destination base station device BS2 which has been connected in the past, it is possible to omit the reservation of radio resources relating to handover, and to effectively utilize radio resources. In addition, for example, even in a case where movement source base station device BS1 or the movement destination base station device BS2 is not able to be processed such as a case where a plurality of terminal devices perform handover all at once, or the like, it is possible to instruct the terminal device UE1 to perform reconnection.

### THIRD MODIFICATION EXAMPLE

An example of the reconnection process has been described in the second modification example, but a reconnection process described in a third modification example may be executed.

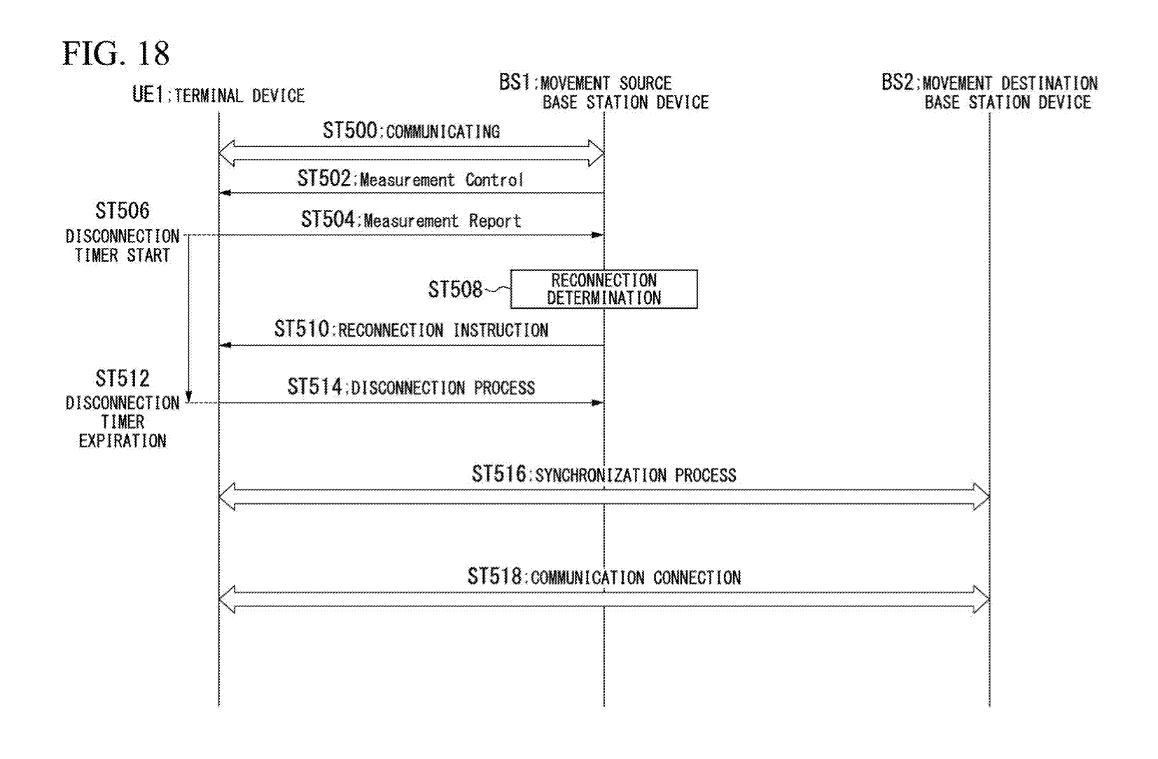

FIG. 18 is a sequence diagram illustrating another example of the reconnection process according to the modification example of the present invention.

In step ST500, the terminal device UE1 communicates with the movement source base station device BS1.

In step ST502, the movement source base station device BS1 transmits Measurement Control indicating an instruction for the measurement of a communication quality to the terminal device UE1.

In step ST504, the terminal device measures a communication quality, and transmits Measurement Report including a measurement result and information of a terminal device relating to handover to the movement source base station device BS1.

In step ST506, the terminal device UE1 starts clocking of a disconnection timer when Measurement Report is transmitted to the movement source base station device BS1. The disconnection timer may be included in the terminal device UE1.

In step ST508, the movement source base station device BS1 determines whether reconnection to the terminal device UE1 is performed based on the information of a terminal device relating to handover included in Measurement Report, a communication quality for each base station device BS (candidate base station device BS) of a peripheral cell, and a communication quality between a host device and the terminal device UE1. The information of a terminal device relating to handover may be, for example, information indicating whether reconnection is executed.

In step ST510, the movement source base station device BS1 generates a reconnection instruction (instruction information) for instructing the terminal device UE1 to perform reconnection to the movement destination base station device BS2. The movement source base station device BS1 transmits the generated reconnection instruction to the terminal device UE1.

In step ST512, in a case where the disconnection timer expires, the terminal device UE1 executes a process of disconnecting communication with the movement source base station device BS1.

In step ST514, in a case where the process of disconnection from the movement source base station device BS1 is completed, the terminal device UE1 confirms the resource allocation information stored by the resource information storage unit 13.

The terminal device UE1 is connected to the movement destination base station device BS2 using radio resources of the movement destination base station device BS2 serving as a base station device which is a reconnection destination, and starts a synchronization process with the movement destination base station device BS2.

In step ST516, in a case where the synchronization process is completed, the terminal device UE1 starts (continues) communication with the movement destination base station device BS2.

In this manner, by reconnection to the movement destination base station device BS2 which has been connected in the past, it is possible to omit the reservation of radio resources relating to handover, and to effectively utilize radio resources. In addition, for example, even in a case where movement source base station device BS1 or the movement destination base station device BS2 is not able to be processed such as a case where a plurality of terminal devices perform handover all at once, or the like, it is possible to instruct the terminal device UE1 to perform reconnection. In addition, since the process of disconnection from the movement source base station device BS1 is started according to the expiration of the disconnection timer, it is possible to reduce various types of communication processing between the terminal device UE1 and the movement source base station device BS1, and to effectively utilize radio resources.

### FOURTH MODIFICATION EXAMPLE

Meanwhile, in each of the embodiments and each of the modification examples described above, an example has been described in which any of the information indicating an instruction for whether the first-type handover is executed, the information indicating an instruction for whether the second-type handover is executed, and the information on whether reconnection is executed is used as the information of a terminal device relating to handover, but any of these pieces of information may be used as the information of a terminal device relating to handover, and the reconnection process may be executed when any handover is not executed using the information indicating an instruction for whether the first-type handover is executed and the information indicating an instruction for whether the second-type handover is executed as the information of a terminal device relating to handover.

### FIFTH MODIFICATION EXAMPLE

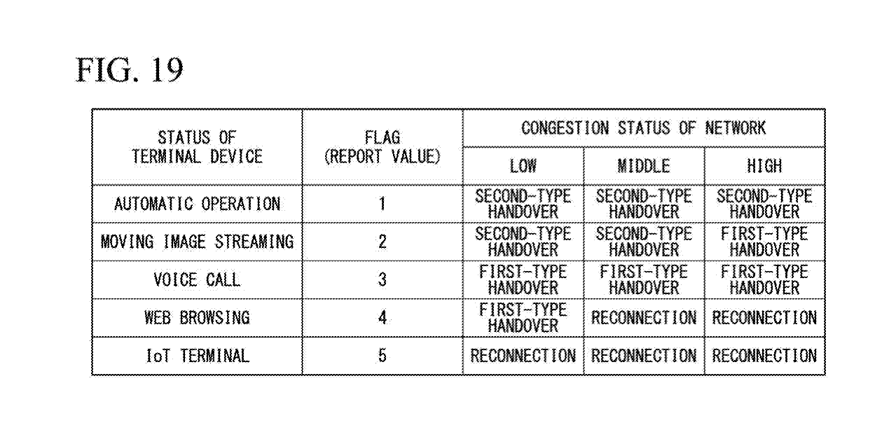

Meanwhile, in each of the embodiments and each of the modification examples described above, an example has been described in which the information of a terminal device relating to handover is the information indicating an instruction for whether the first-type handover is executed, the information indicating an instruction for whether the second-type handover is executed, the information on whether reconnection is executed, and the like, but the information of a terminal device relating to handover may be information indicating the status of a terminal device such as the communication status or use status of the terminal device. In this case, the movement source base station device BS1 may determine whether the first-type handover is executed, whether the second-type handover is executed, or whether reconnection is executed, in accordance with the status of the terminal device. In this case, the movement source base station device BS1 may refer to, for example, a flag according to the status of the terminal device and a handover type determination table according to the congestion status of a network. A description will be given with reference to FIG. 19.

FIG. 19 is a table indicating an example of a handover type determination table according to the modification example of the present invention.

The handover type determination table is a table in which the status of a terminal device, a flag (report value), and the congestion status of a network are associated with each other.

The status of a terminal device indicates the use status of an application in the terminal device UE1 such as, for example, automatic operation, moving image streaming, a voice call, web browsing, or an IoT terminal.

The flag (report value) is a value according to the status of each terminal device, and is a value included in Measurement Report as the information of a terminal device relating to handover.

The congestion status of a network has “first-type handover” indicating the first-type handover, “second-type handover” indicating the second-type handover, and “reconnection” indicating the reconnection associated with each other by levels of, for example, “low,” “middle,” and “high.”. For example, “low” indicates that unallocated resources equal to or greater than 50%, “middle” indicates unallocated resources equal to or greater than 20% and less than 50%, and “high” indicates unallocated resources less than 20%.

This table may be stored by, for example, the movement source base station device BS1.

For example, in a case where the terminal device UE1 is a terminal device UE1 used in automatic operation, a time relating to handover is short, and the “second-type handover” having a success rate higher than that of the “first-type handover” is determined as a handover type regardless of the congestion status of a network. That is, in a case where the terminal device UE1 transmits a flag value “1” corresponding to the “automatic operation” which is the status of a terminal device as the information of a terminal device relating to handover, the movement source base station device BS1 may executes the second-type handover process as information indicating an instruction for the execution of the second-type handover.

In addition, for example, in a case where the terminal device UE1 is a terminal device UE1 used in the moving image streaming, the “second-type handover” is determined as a handover type when the congestion status of a network is “high,” and the “first-type handover” is determined as a handover type in other cases. That is, in a case where the terminal device UE1 transmits a flag value “2” corresponding to the “moving image streaming” which is the status of a terminal device as the information of a terminal device relating to handover, the movement source base station device BS1 may confirm the congestion status of a network, and finally determine which handover type is executed in accordance with the congestion status. That is, the terminal device UE1 transmits the value of a flag as the information of a terminal device relating to handover, whereby the movement source base station device BS1 may be instructed to execute which handover type, and whether the movement source base station device BS1 follows the instruction of the terminal device UE1 may be determined depending on the congestion status of a network.

The voice call, the web browsing, and the IoT terminal are as shown in the drawing, and the description thereof will not be given.

In this manner, it is possible to switch between handover types depending on the priority of communication such as the use status of an application of a terminal device or how the terminal device is used, or the like. Therefore, for example, as compared with a case where all the terminal devices perform the second-type handover, it is possible to reduce radio resources to be secured in advance, and to effectively utilize radio resources.

### SIXTH MODIFICATION EXAMPLE

Meanwhile, in the information of a terminal device relating to handover, any one of or a plurality of the information indicating an instruction for whether the first-type handover is executed, the information indicating an instruction for whether the second-type handover is executed, the information on whether reconnection is executed, and the status of a terminal device may be used.

Meanwhile, the status of a terminal device may be set in accordance with various parameters such as throughput, the amount of traffic, the type of calling, the number of packets, the amount of data, the priority of communication, and the urgency of communication.

Meanwhile, the information of a terminal device relating to handover may be information indicating an instruction for which handover or reconnection is not executed.

Meanwhile, even in a case where the information of a terminal device relating to handover is received, the movement source base station device BS1 may cause the terminal device to perform a handover process different from a handover process or a reconnection process supported by the information of a terminal device relating to handover in accordance with the congestion status of a host device or the like.

Meanwhile, an example in which the information of a terminal device relating to handover is included in Measurement Report has been described, but the information may be included in Capability Message instead of Measurement Report. The Capability Message may be transmitted before each handover process or reconnection process is started, for example, in an attachment process.

Meanwhile, an aspect of the present invention may be realized by combining one or a plurality of embodiments and modification examples described above, or some or all of the embodiments and the modification example described above.

Meanwhile, a program operating in the terminal devices UE1, UE1A, and UE1B, and the base station devices BS in an aspect of the present invention may be a program (program causing a computer to function) for controlling one or a plurality of processors such as a central processing unit (CPU) so as to realize functions shown in each of the embodiments and each of the modification examples relating to an aspect of the present invention. Information which is handled in each of these devices may be temporarily accumulated in a random access memory (RAM) during processing of the information, be stored in various storages such as a flash memory or a hard disk drive (HDD) thereafter, be read out by a CPU or the like as necessary, and be corrected or written.

Meanwhile, some or all of the terminal devices UE1, UE1A, and UE1B, and the base station devices BS in each of the embodiments and the modification examples described above may be realized by a computer including one or a plurality of processors. In that case, a program for realizing this control function may be recorded in a computer readable recording medium, and be realized by causing a computer system to read and execute the program recorded in this recording medium.

Meanwhile, the term “computer system” as used herein is a computer system built into the terminal devices UE1, UE1A, and UE1B, and the base station devices BS, and is assumed to include an OS or hardware such as peripheral devices. In addition, the term “computer readable recording medium” refers to a portable medium such as a flexible disk, a magneto-optic disc, a ROM, or a CD-ROM, and a storage device such as a hard disk built into the computer system.

Further, the “computer readable recording medium” may also include recording mediums that dynamically hold a program during a short period of time like networks such as the Internet or communication lines when a program is transmitted through communication lines such as a telephone line, and recording mediums that hold a program for a certain period of time like a volatile memory inside a computer system serving as a server or a client in that case. In addition, the above-mentioned program may be a program which is used for realizing a portion of the aforementioned functions, and may be a program which is capable of realizing the aforementioned functions by a combination of programs previously recorded in the computer system.

In addition, some or all of the terminal devices UE1, UE1A, and UE1B, and the base station devices BS in each of the embodiments and modification examples described above may be typically realized by an LSI such as an integrated circuit, and may be realized by a chip set. In addition, each functional block of the terminal devices UE1, UE1A, and UE1B, and the base station devices BS in each of the embodiments and modification examples described above may be individually formed as a chip, and some or all of the functional blocks may be integrated and be formed as chips. In addition, a method of forming an integrated circuit may be realized using a dedicated circuit and/or a general-purpose processor without being limited to an LSI. In addition, in a case where an integrated circuit forming technique for replacement with an LSI appears with the development of semiconductor technology, it is also possible to use an integrated circuit formed using the technique.

Hereinbefore, each of the embodiments and modification examples has been described in detail as an aspect of this invention with the accompanying drawings, but specific configurations are not limited to each of the embodiments and modification examples, and also include a change in design and the like without departing from the scope of this invention. In addition, an aspect of the present invention can be changed variously in the scope shown in claims, and embodiments obtained by appropriately combining technical means disclosed in each different embodiment are also included in the technical scope of the present invention. In addition, configurations in which elements that are described in each of the embodiments and modification examples and exhibit the same effect are replaced with each other are included in the technical scope.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

UE1, UE2 Terminal device

BS1, BS1A, BS1B Movement source base station device

BS2, BS2A, BS2B Movement destination base station device

BS3 Candidate base station device

11 Communication unit

111 Reception unit

112 Transmission unit

12, 12B Control unit

120 Measurement unit

121 Report generation unit

123 Connection unit

124 Information generation unit

125 Resource management unit

126 Notification generation unit

127B Type information generation unit

13 Resource information storage unit

101 CPU

102 Storage medium interface unit

103 Storage medium

104 Input unit

105 Output unit

106 ROM

107 RAM

108 Auxiliary storage unit

109 Network interface unit

30 Communication unit

301 Reception unit

302 Transmission unit

31, 31A Control unit

310, 310A, 310B Measurement instruction unit

311, 311A, 311B Determination unit

312, 312A, 312B Request unit

313, 313A, 313B Instruction unit

314A Cancel processing unit

315B Decision unit

40 Communication unit

401 Reception unit

402 Transmission unit

41, 41A Control unit

411, 411A Request acceptance unit

412, 412A Synchronization processing unit

413, 413A Resource allocation unit

414, 414A Connection unit

415A Resource release unit

42 Terminal information storage unit

201 CPU

202 Storage medium interface unit

203 Storage medium

204 Input unit

205 Output unit

206 ROM

207 RAM

208 Auxiliary storage unit

209 Network interface unit

What is claimed is:

1. A wireless communication system comprising:
a terminal device;
a first base station device; and
a second base station device,
wherein the terminal device includes a terminal device communication unit and a terminal device control unit,
the terminal device control unit
transmits a measurement result relating to a radio wave environment and connection switching means information indicating which of two or more means of connection switching to another base station device is used to the first base station device through the terminal device communication unit,
receives instruction information corresponding to the transmitted connection switching means information from the first base station device through the terminal device communication unit, and
performs connection with the second base station device based on the instruction information,
the first base station device includes a first base station device control unit and a first base station device communication unit, and
the first base station device control unit
receives the measurement result and the connection switching means information from the terminal device through the first base station device communication unit, and
transmits instruction information corresponding to the received connection switching means information to the terminal device through the first base station device communication unit.

2. A terminal device comprising:
a communication unit; and
a control unit,
wherein the control unit
transmits a measurement result relating to a radio wave environment and connection switching means information indicating which of two or more means of connection switching to another base station device is used to a first base station device through the communication unit,
receives instruction information corresponding to the transmitted connection switching means information from the first base station device through the communication unit, and
performs connection with a second base station device based on the instruction information.

3. The terminal device according to claim 2,
wherein the connection switching means information includes first information indicating whether a host device performs handover.

4. The terminal device according to claim 3,
wherein the first information includes information indicating a use state of the terminal device.

5. The terminal device according to claim 2,
where the instruction information includes reconnection instruction information.

6. The terminal device according to claim 2,
wherein the control unit starts a timer in a case where the measurement result is transmitted through the communication unit, and cuts off connection with the first base station device in a case where the timer expires.

7. A base station device comprising:
a control unit; and
a communication unit,
wherein the control unit
receives a measurement result relating to a radio wave environment and connection switching means information indicating which of two or more means of connection switching to another base station device is used from a terminal device through the communication unit, and
transmits instruction information corresponding to the received connection switching means information to the terminal device through the communication unit.

8. A wireless communication method comprising causing a computer of a terminal device to:
transmit a measurement result relating to a radio wave environment and connection switching means information indicating which of two or more means of connection switching to another base station device is used to the first base station device;
receive instruction information corresponding to the transmitted connection switching means information from the first base station device; and
perform connection with a second base station device based on the instruction information.

9. A non-transitory computer readable recording medium storing a program for causing a computer of a terminal device to execute:
transmitting a measurement result relating to a radio wave environment and connection switching means information indicating which of two or more means of connection switching to another base station device is used to a first base station device;
receiving instruction information corresponding to the transmitted connection switching means information from the first base station device; and
performing connection with a second base station device based on the instruction information.
